(19) United States
(12) Patent Application Publication
(10) Pub. No.: US 2005/0050227 A1
(43) Pub. Date: Mar. 3, 2005

(54) Method and system for peer-to-peer directory services

(75) Inventor: Eric H. Michelman, Bellevue, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Cascade Basic Research Corp., Bellevue, WA (US)

(21) Appl. No.: 10/886,163

(22) Filed: Jul. 6, 2004

Related U.S. Application Data
(60) Provisional application No. 60/484,803, filed on Jul. 3, 2003.

(51) Int. Cl. G06F 15/16

(52) U.S. Cl. 709/245

(57) ABSTRACT

Methods and systems for providing directory services for peer-to-peer systems and applications are provided. Example embodiments provide a Peer-to-Peer Directory System (“PPDS”), which enables applications, especially those using peer-to-peer technology that desire to communicate directly with one another on different peer computer systems, to automatically discover working (current) network addresses for each other even when the network addresses of their respective computer systems change dynamically. The PPDS provides a community-based tracking system, a portion of which is implemented on each computer system that is a member of the community, to mutually track and store the network addresses of the other computer systems to which it has an associated relationship. The PPDS also provides a query mechanism that takes advantage of the relationship paths between the various computer systems to search for a current network address of a designated computer system.

### BACKGROUND OF THE INVENTION

1. Field of the Invention

The present invention relates to methods and systems for maintaining and tracking computer system network addresses and, in particular, to methods and systems for providing peer-to-peer directory services without an intermediary server.

2. Background Information

One of the hurdles in designing and running “peer-to-peer” applications on computer systems is obtaining the current network addresses of the other computer systems with which the peer-to-peer applications desire to communicate. Peer-to-peer applications are applications that communicate with and exchange data between two or more computer systems using peer-to-peer technology. For example, using peer-to-peer technology, data is transferred directly from one computer system to another using, without requiring an intervening server. Peer-to-peer technology and background information on peer-to-peer computing is described further in Oram, Andy, Peer to Peer: Harnessing the Benefits of a Disruptive Technology, O'Reilly and Assocs., Inc., 2001, which is incorporated herein by reference in its entirety.

In such environments, network addresses are often dynamic, and peer computer systems are not always available, because they may, for example, be intermittently connected to the network or be otherwise off-line. In particular, home computer systems commonly do not have a consistent Internet address (known as an IP address). For example, with dial-up Internet access, a computer is assigned a different IP address each time it connects (each time it dials up) typically from a pool of IP addresses. Even with “always on” connections such as DSL, ADSL, and cable, the computer system doesn't “own” its IP address—an address is assigned and periodically changed by the ISP (Internet Service Provider) that provides connection service to the Internet. Thus, even though an address for a computer system may be known at one instant, it may no longer be usable the next time an application attempts to communicate with that computer system.

The issue of discerning a network address for a peer computer system is rarely confronted outside of the home (or home-like) environment, since computer systems outside the home typically have “static” IP addresses that do not change. Such systems typically invoke a well-known “name service,” such as through a DNS server on the network, to translate friendly domain names such as “yahoo.com” and “msn.com” into usable IP addresses. DNS servers are part of a Domain Name System (typically itself a network within the Internet) that implements name to network address mappings for networks such as the Internet. For example, when a user enters an address such as “msn.com” into a browser, the user's computer system contacts a DNS server with a known (and static) IP address to retrieve “msn.com's” corresponding IP address. The DNS server may contact other DNS servers as needed until the IP address that corresponds to “msn.com” is determined. The computer system is thereafter able to directly contact the “msn.com” server using the retrieved IP address.

Servers like “yahoo.com” or “msn.com” do occasionally change their IP addresses (they have many of them corresponding to different parts of the services they offer) or may add new ones. When address changes occur, the server is responsible for notifying the DNS system of its address change, after which, a day or so is required before the changes are propagated throughout all of the (related) DNS servers in the world.

In some cases, it makes sense for computer systems in home-like environments that connect to the Internet to obtain static IP addresses with user friendly names that are maintained with the Internet DNS system to avoid the problems associated with dynamic addresses. However, in many cases such a solution is cost-prohibitive. Each such computer system needs to have a domain name, which is maintained with the Internet DNS system so that other computer systems can locate it, and a static IP address, both of which add expense.

In other cases, computer systems with dynamic IP addresses that desire to communicate with each other have incorporated approaches that require more involvement by the user of the computer system or the system itself. These systems also utilize an independent “directory service” or “directory server” to store and serve network addresses. In this case though, the independent directory server is a network-accessible server, with a known (and static) address, that is invoked by an application to record its own network address for access by others and to retrieve the network addresses of other computer systems. Thus, the directory server acts as an intermediary between computer systems that use it.

Such intermediary directory servers can exist in different forms. In one form, a centralized computer system(s) operates to maintain the addresses of its members/subscribers. The central directory service acts as a kind of current “phone book,” and each computer system must notify the directory service of its current address every time the user comes “on-line” with the application (e.g., the system comes on-line and registers with the application) or otherwise potentially changes its address. Napster and the Instant Messaging (IM) services such as AOL and MSN, as well as other services, use such an approach. Each service/application maintains an established central server, with a static IP address served by the DNS, which intermediates between subscriber computer systems. So when a subscriber of the application comes on-line, the subscriber's computer system (or in some cases the subscriber) is responsible for connecting to the central directory server (the directory server's address is available through the DNS), to notify the directory server of its currently assigned IP address. When two users or computer systems want to communicate directly with each other (such as through an application), each must first contact the directory server to determine the other's current IP address, after which the two computer systems can communicate directly. Essentially, the directory server acts as a surrogate for a DNS system for its own particular application/system—maintaining a translation system from “friendly names” known within the application to current IP addresses. Because network addresses can change, a peer-to-peer application typically needs to determine or check the validity of a computer system's network address typically at the start of each communication session, re-retrieving it from the directory service as needed. And, when a computer system's network address does change (e.g., it's assigned a new IP address), the application needs to again notify the directory service.

A second form of intermediary directory servers offers a de-centralized approach, known as “fluid” directory servers. Fluid directory servers have static IP addresses, but there are typically one or more of them, and they may dynamically join or leave the application network (for example, as they make themselves available to provide directory service for a particular application or then cease to do so). Each directory server that is present on the network at a particular time can intermediate between the computer systems “connected” to it, and each computer system may connect to any one or more of the directory servers. Thus, one particular computer system cannot count on a second particular computer system being connected to the same directory server at a particular point in time to locate or communicate specifically with the second computer system. Therefore, this form of directory server isn't generally useful for peer-to-peer applications that need to connect particular users to each other such as IM applications. Rather, applications in which the respective computer systems are “fungible” (not valued for their uniqueness, but rather for a common characteristic) are best suited for such an approach. File sharing services, such as Gnutella and Kazaa, use this form of the intermediary directory server approach. These services connect together different computer systems to offer a desired commodity such as copies of a particular song. Which computer supplies the copy is not important—just that the copy is available.

One problem with most centralized and fluid directory services is that they are application specific—they support their own applications and are not available to third party applications. The expense of maintaining large centralized banks of server machines contributes substantially to this unavailability. Directory services provided by AOL and MSN are subsidized by advertising revenue. Other directory services charge directly for their use, for example through subscription fees. “Jabber.com” is one central directory service that is available to third party applications and is not application-specific; however, there is an expense associated with its use. Another problem with such solutions is privacy—many users are reticent to share information with centralized services because they cannot control the dissemination of the information once it is shared.

Another approach to supporting communication between computer systems with dynamic IP addresses involves the explicit exchange of network addresses, for example, by manual entry of an IP address when needed by an application. Applications that use this approach typically utilize a user interface (UI) for entering another user's (computer system's) IP address. The IP addresses can be exchanged “offline,” such as by a telephone call or through email. Because of the tedium involved in entering this data, potential for making errors, and lack of understanding of IP addresses by non-technical users, this approach works only in limited situations. In addition, when network addresses change, the application needs to be notified by the user. Thus, the manual method is onerous to the user and unreliable, because it may be difficult for a user to keep track of what or who needs to be notified.

### BRIEF SUMMARY OF THE INVENTION

Embodiments of the present invention provide computer-and network-based methods and systems for providing directory services for peer-to-peer systems and applications. Example embodiments provide a Peer-to-Peer Directory System (“PPDS”), which enables applications, especially those using peer-to-peer technology that desire to communicate directly with one another on different peer computer systems, to discover working (current) network addresses for each other in an automated fashion even when the network addresses of their respective computer systems change dynamically. The PPDS provides a community-based tracking system, a portion of which is implemented on each computer system that is a member of the community, to mutually track and store the network addresses of the other computer systems to which it has an associated relationship. The PPDS also provides a query mechanism that takes advantage of the relationship paths between the various computer systems to search for a current network address of a designated computer system. The PPDS can provide directory services in conjunction with or without the use of an intermediary server with a known network address.

In one example embodiment, the Peer-to-Peer Directory Service comprises one or more functional components/modules that work together to provide correspondent tracking and location. The PPDS comprises a plurality of PPDS portions executed by each member computer system of a community. For example, a PPDS portion may comprise a tracking and location service, which includes a tracking agent and a location service; a correspondent information data repository; a user interface; and an application interface. The tracking agent forwards changes to the computer system's network address, and potentially network address information for a tracked number of levels of correspondents to its correspondents via a network, and receives similar messages from its correspondents via the network. The tracking agent stores received network addresses and network address information in the correspondent information data repository. The location service uses the network and network addresses retrieved from the data repository to contact correspondent computer systems to automatically determine a network address for a target correspondent computer system.

According to one approach, a network address for a target correspondent is automatically determined by receiving and storing network address information for a plurality of computer systems, at least one of which has a dynamically changing address, designating a target correspondent, and contacting another correspondent to retrieve the current network address of the designated target correspondent. In some embodiments, member computer systems in the community are queried based upon correspondent information stored locally to locate the current network address of the designated target correspondent. In other embodiments, member computer systems in the community are searched recursively to allow the PPDS to locate the current address for the target correspondent by querying correspondents down relationship paths. In some embodiments, the determining of a network address for a target correspondent occurs periodically and in other embodiments a target correspondent is designated by receiving a request for a target correspondent's address. In some instances, the network addresses that are tracked are public network addresses, in others they are private addresses, and yet in others they are a combination of both. The network addresses may be heterogeneous or homogeneous.

According to another approach, a network address for a member correspondent is forwarded to other member computer systems after the network address for the member correspondent has been updated. This provides a mechanism for the member computer systems to be informed on a periodic basis of updates to network addresses. In some embodiments, the member's updated network address is forwarded to direct and indirect correspondents of the member computer system. In other embodiments, the member's updated network address is forwarded to the direct correspondents of the member computer system, which are then responsible for propagating the updated network address. In some embodiments, network address information that relates to the direct correspondents of the direct correspondent is also forwarded. In some embodiments, it is not. In some embodiments, network address information that relates to the indirect correspondents of the direct correspondent is also forwarded. In some embodiments, the information (whether for direct or indirect correspondents) is propagated from direct correspondent to direct correspondent. In some situations, network address information for other correspondents may be sent together with the updated network address. In other situations, they may be forwarded separately or portions not forwarded at all.

According to yet another approach, a network address for a direct correspondent along with network address information for its direct and indirect correspondents is forwarded to a new direct correspondent. In some situations, the information is forwarded when the direct correspondent is notified that it is to track the new direct correspondent. In some embodiments, the network address for the direct correspondent along with the network address information for its direct and indirect correspondents is forwarded on a periodic basis.

In some scenarios, indirect correspondents are tracked to a number of levels of indirection. In some approaches, the tracking level is user settable and may be specific to a computer system. In other approaches, an agreed upon community tracking level is maintained.

According to one approach, the tracking of a particular correspondent or its elimination from community tracking is specifiable by a user or by an application.

### BRIEF DESCRIPTION OF THE DRAWINGS

FIG. 1 is an example block diagram of a computer system environment for providing an example Peer-to-Peer Directory System.

FIG. 2 is an example overview flow diagram of use of a Peer-to-Peer Directory Service in a computer system.

FIG. 3 is an example block diagram of the direct correspondents of a computer system.

FIG. 4 is an example block diagram of a community of correspondents of a computer system that includes direct and indirect correspondents.

FIG. 5 is an example block diagram of the same community of correspondents shown as discrete hierarchical levels of correspondents.

FIG. 6 is an example block diagram of components of an example peer-to-peer directory service portion executed by each member computer system.

FIG. 7 is an example block diagram of a general purpose computer system for practicing embodiments of a peer-to-peer directory service portion.

FIGS. 8A and 8B are an example block diagrams of the correspondent information of a Peer-to-Peer Directory Service stored in a data repository.

FIG. 9 is an example block diagram of a method for using email to obtain a network address for a correspondent.

FIG. 10 is an example flow diagram of a PPDS routine to track a new direct correspondent.

FIG. 11 is an example flow diagram of a routine executed by an example peer-to-peer directory system portion in response to receiving a network address tracking message to add a new correspondent.

FIG. 12 is an example flow diagram of a routine executed by an example peer-to-peer directory system portion for updating or adding correspondent information to a correspondent information data repository.

FIGS. 13A and 13B are an example flow diagram of a routine executed by an example peer-to-peer directory system portion in response to receiving a network address tracking message to update a network address of a correspondent.

FIG. 14 is an example flow diagram of a routine executed by an example peer-to-peer directory system portion of a resident computer system for deleting a direct correspondent from the Peer-to-Peer Directory Service.

FIG. 15 is an example flow diagram of a routine executed by an example peer-to-peer directory system portion in response to receiving a network address tracking message to delete a correspondent.

FIGS. 16A and 16B are example flow diagrams of an alternate routine to find a correspondent's new network address in an example community-based peer-to-peer directory service.

FIG. 17 is an example flow diagram of a routine to attempt to contact a correspondent using a potential network address to retrieve a current address for a target correspondent in an example community-based Peer-to-Peer Directory Service.

FIG. 18 is an example flow diagram of a routine executed by an example peer-to-peer directory system portion for broadcasting an updated network address for the resident computer system to its correspondents.

FIG. 19 is an example flow diagram of a routine executed by an example peer-to-peer directory system portion in response to receiving a network address update message to update a network address of a correspondent.

FIGS. 20A and 20B are an example flow diagram of a routine to find a correspondent's new network address in an example community-based peer-to-peer directory service.

### DETAILED DESCRIPTION OF THE INVENTION

Embodiments of the present invention provide computer- and network-based methods and systems for providing directory services for peer-to-peer systems and applications. Example embodiments provide a Peer-to-Peer Directory System (“PPDS”), which enables applications, especially those using peer-to-peer technology that desire to communicate directly with one another on different peer computer systems, to discover working (current) network addresses for each other in an automated fashion even when the network addresses of their respective computer systems change dynamically. The PPDS can provide directory services in conjunction with or without the use of an intermediary server with a known network address. The PPDS takes advantage of the phenomenon that individuals and applications have communities of correspondents of which they are a part, and uses those correspondents and the inherent relationships between them to help track and locate the current network address each individual's computer system. The computer systems that belong to such a community will be generally referred to as “peer” computer systems, because they typically utilize peer-to-peer technologies to communicate and interact with each other, and because the PPDS technologies are particularly useful in such environments. However, one skilled in the art will recognize and understand that the PPDS is also useful in communities with computer systems that run more traditional client-server applications, or a mixture of client-server and peer-to-peer applications, as well.

In an PPDS environment that involves computer systems with dynamically changing addresses, changes to network addresses are broadcast to other computer systems that are within a sphere of computer systems that interact. It is likely that one or more of these other computer systems does not receive the network address update because it is not on-line or otherwise connected to the network at the time the update is broadcast. Thus, when the other computer system comes back on-line, it will need to somehow obtain the updated network address.

The PPDS provides a community-based tracking system, a portion of which is implemented on each computer system that is a member of the community, to mutually track and store the network addresses of the other computer systems to which it has an associated relationship. The PPDS also provides a query mechanism that takes advantage of the relationship paths between the various computer systems to search for a current network address of a designated computer system. Through the tracking system and query mechanism, the PPDS provides an automated method for discovering a current network address for the designated computer system, without user involvement, once the designated computer system is known to some member of the community of computer systems, by determining from other related member computer systems the current network address of the designated computer system. Thus, by distributing the responsibility for tracking network addresses to member computer systems in a community formed by the natural relationships inherent in application and user communication, the PPDS avoids the expense and management involved in utilizing the intermediary directory services and servers of traditional techniques.

Each member computer system is responsible for transmitting network address information to the other member computer systems of the community with which it has an associated relationship and for collecting and storing network address information it receives. Each computer system typically transmits its own network address and an effective date and time typically whenever its address changes; the addresses of other computer systems with which it maintains relationships; and the addresses received from these other computer systems, which typically includes addresses of other member computer systems with which they maintain a relationship, up to a settable (or predetermined) number of levels. The transmission of network address information may take place at different times or at other times, such as on a periodic basis or triggered by some event. In addition, the addresses of the other computer systems may be transmitted at different times or at the same time as when the computer systems transmits its own address.

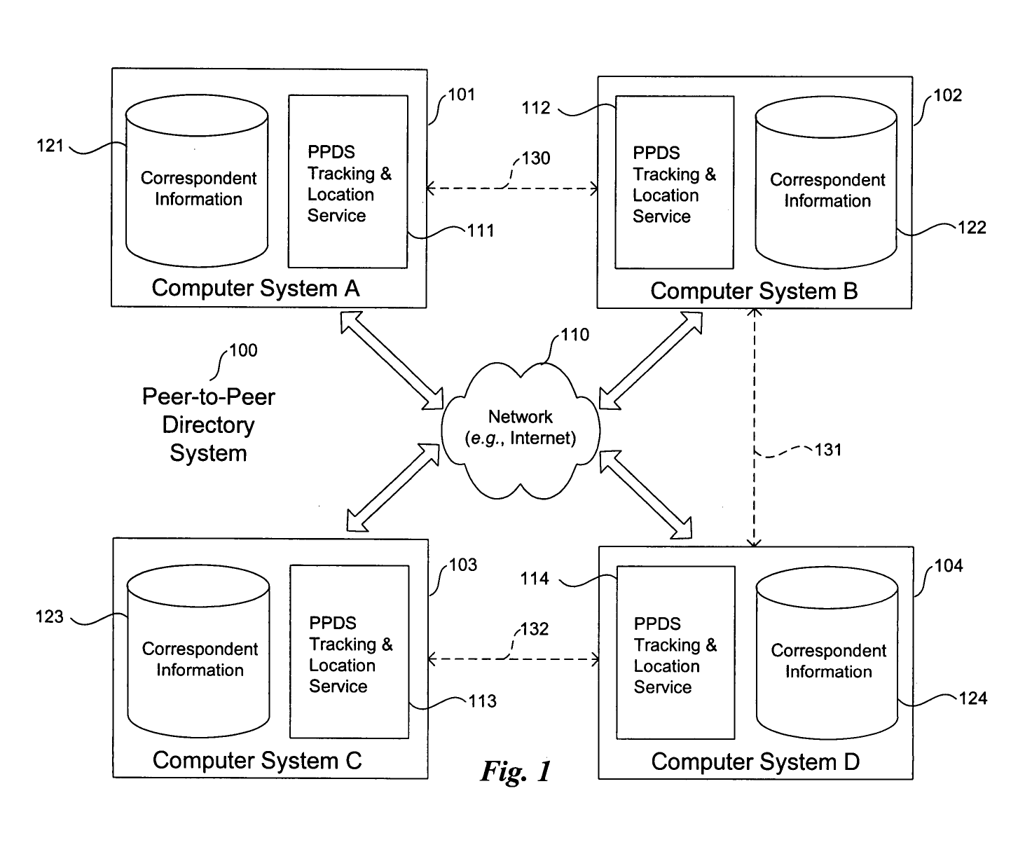

FIG. 1 is an example block diagram of a computer system environment for providing an example Peer-to-Peer Directory System. In FIG. 1, computer systems 101-104 are member computer systems of an example PPDS community 100, which are connected via a network 110, such as the Internet. The PPDS is an abstraction that is implemented by a plurality of PPDS portions executed by each member computer system 101-104. Each PPDS portion has a PPDS tracking and location service 111-114, which collects and manages network address information for each of the other member computer systems in the PPDS community 100 and stores the information in its respective correspondent information data repository 121-124.

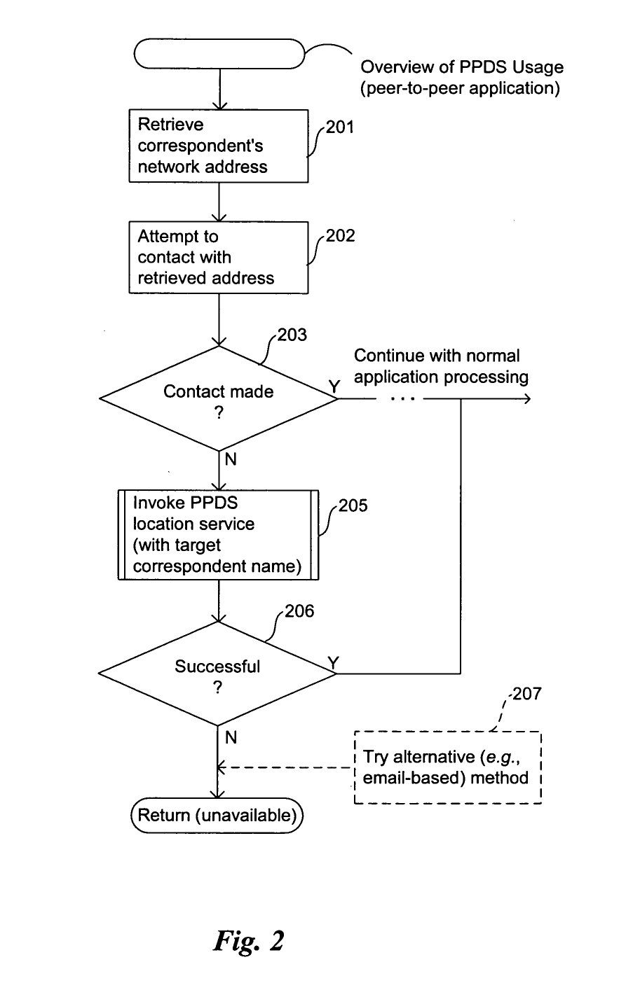

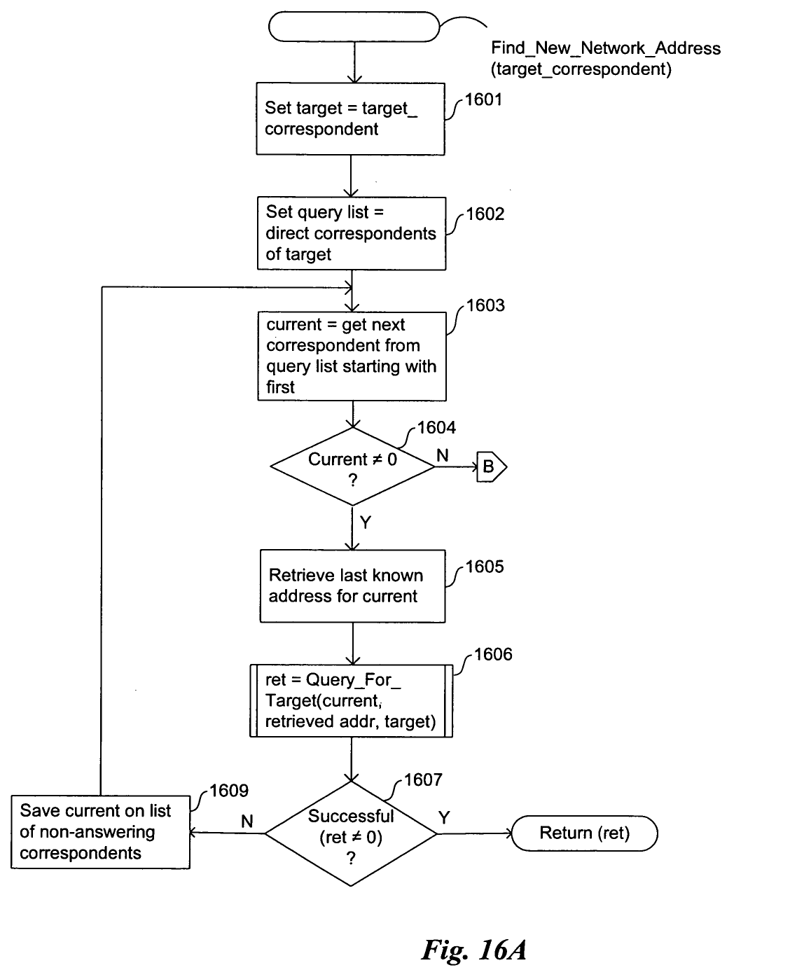

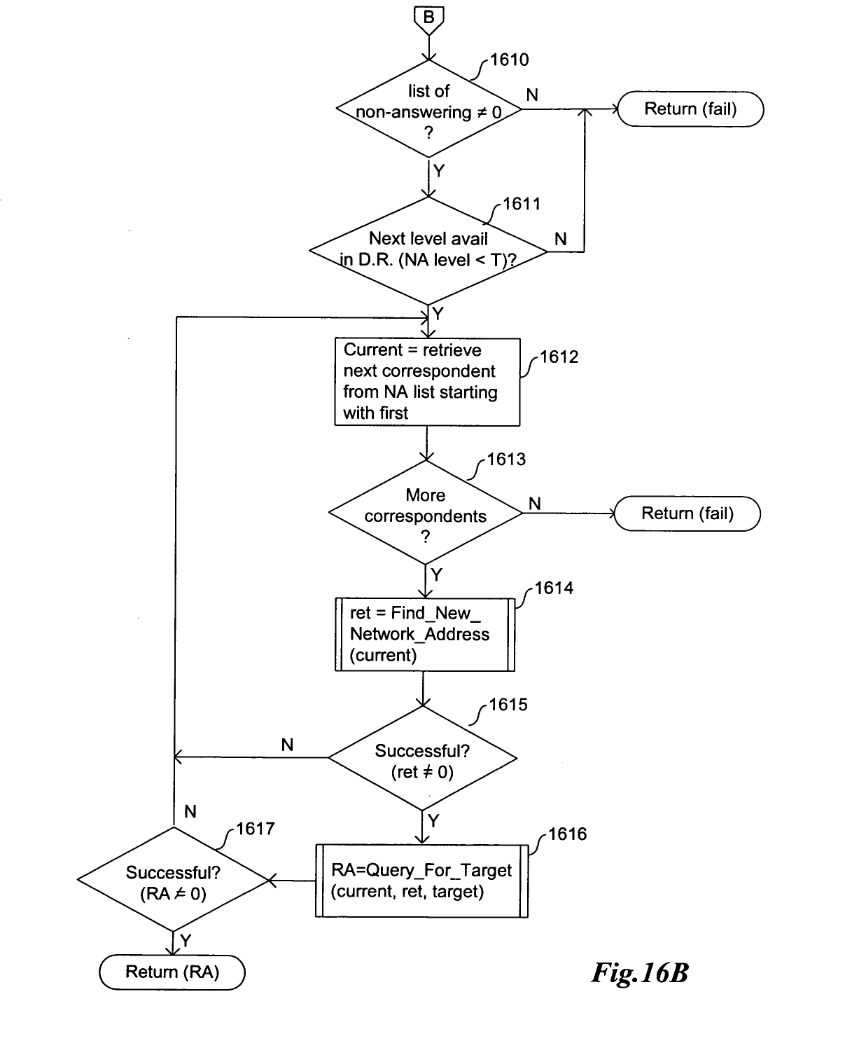

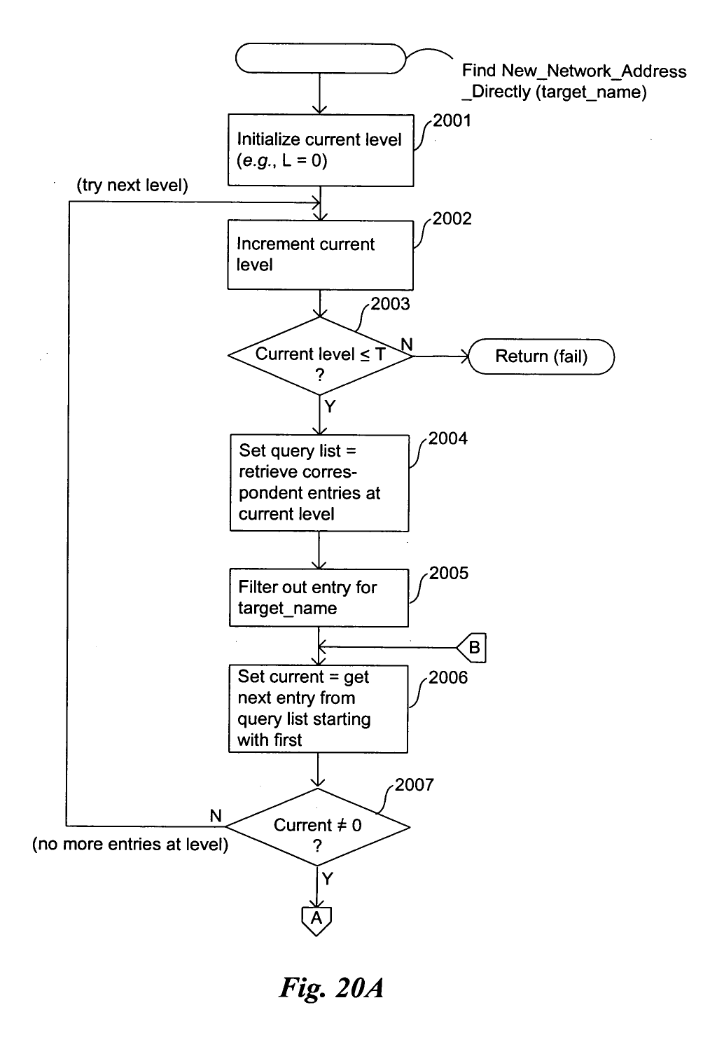

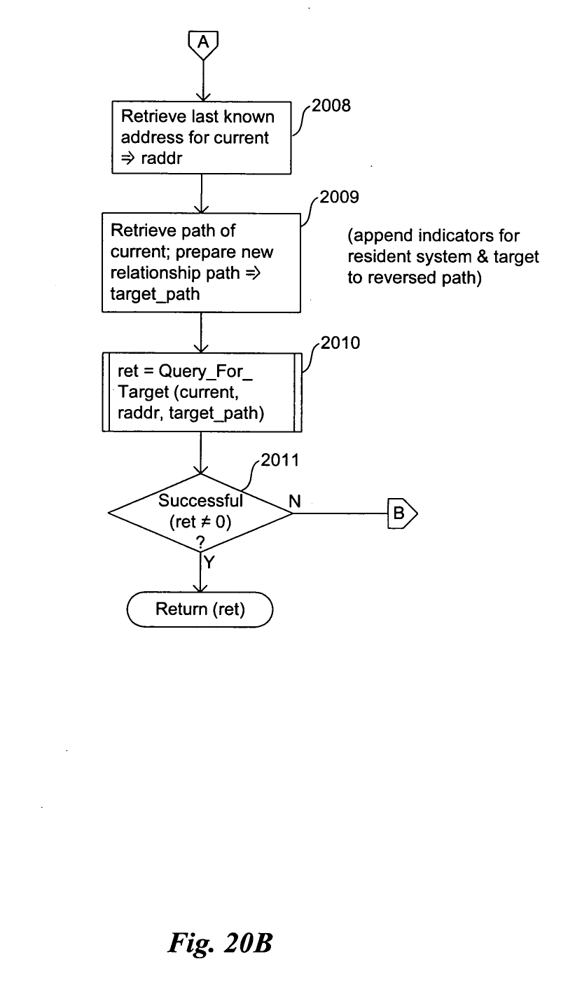

FIG. 2 is an example overview flow diagram of use of a peer-to-peer directory service in a member computer system. Typically, a peer-to-peer application that executes on a resident computer system and desires to communicate directly with one of its correspondent computer systems will contact the PPDS (the PPDS portion executing on the resident computer system) to locate the correspondent computer system if it cannot do so on its own. Specifically, in step 201, the peer-to-peer application retrieves the last known network address for the correspondent computer system. In step 202, the application attempts to contact the correspondent computer system using the retrieved network address. In step 203, if contact was successfully made, then the application continues with its normal processing, otherwise continues in step 205. In step 205, the application invokes a PPDS location service routine designating the correspondent as the target for which a current address is sought. Two such routines, “Find_New_Network_Address” and “Find_New_Network_Address_Directly are described below with reference to FIGS. 16A, 16B, 20A, and 20B. In step 206, if the PPDS successfully located the correspondent computer system, then the application continues with its normal processing, otherwise returns with an application dependent indication that the correspondent computer system was unavailable.

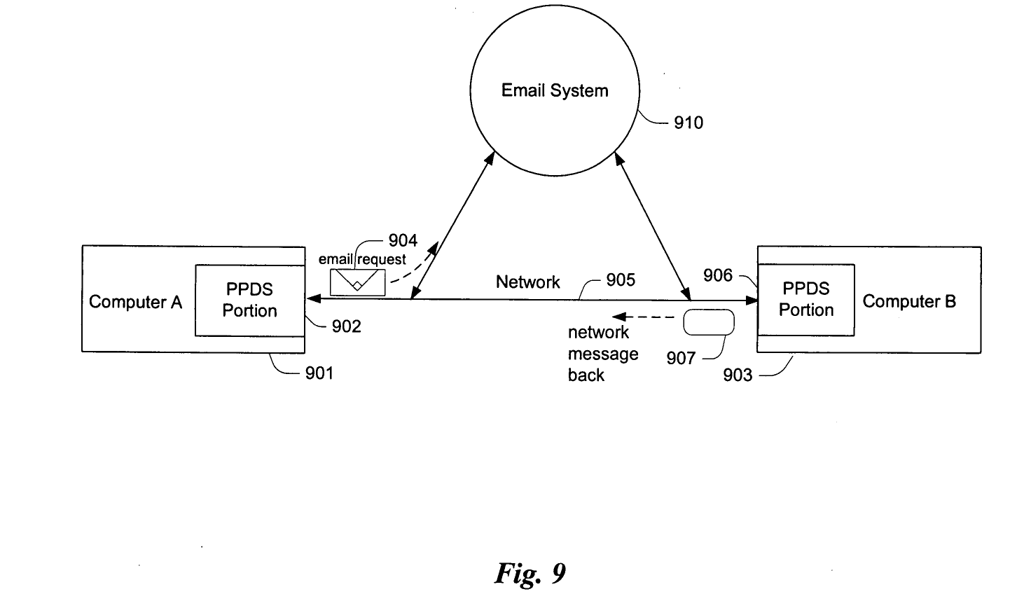

In one embodiment of the PPDS, alternative mechanisms for finding a current network address can be additionally employed as a backup or secondary mechanism to the community-based tracking and locating services described. Such mechanisms are indicated as optionally invoked in step 207. For example, although not likely to yield an immediate response, the application can optionally choose to use email to send the correspondent computer system its resident computer system's address and request a network message back that contains the correspondent computer system's current network address. This mechanism is described further with respect to FIG. 9. Such alternative or secondary mechanisms can also be used to initialize the correspondent information data repository when network addresses aren't immediately known, but an email address of a correspondent computer system is available.

Each member computer system in a PPDS community typically communicates with one or more of the other member computer systems over one or more networks, either through applications or users of the computer systems. The relationships (associations, contacts, affiliations, or connections, etc.) between the computer system applications or users may be “direct” or may be “indirect.” Within a community of peer computer systems, there may be many direct and indirect relationships between the various systems and therefore many direct and indirect correspondents.

For example, two computer systems may have a direct relationship, either through an application running on a first computer system that communicates (or is otherwise directly associated) with an application running on a second computer system or through the users of both computer systems. In this case, each of the computer systems (or an application executing on them or their users) is referred to as a “direct correspondent” of the other computer system. For example, two peer-to-peer applications that send one or more messages between themselves over a network are direct correspondents.

On the other hand, two computer systems may have an indirect relationship, if they do not directly communicate (or otherwise directly associate) with each other, but both communicate with (or are otherwise associated with) a third computer system that communicates with both the first and second computer system. Because of the direct communication, the second and third computer systems are direct correspondents, as are the first and third computer systems. However, the relationship between the first computer system and the second computer system is indirect through a relationship path via the third computer system. The first and second computer systems (or an application executing on them or their users) are referred to as an “indirect correspondents” relative to each other.

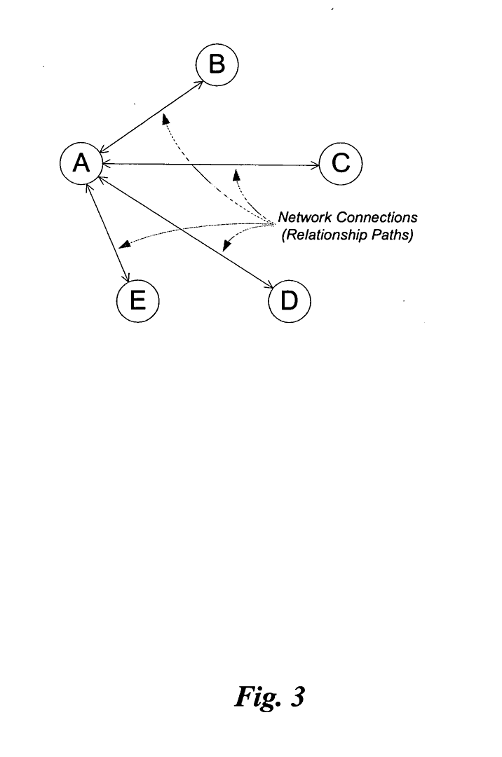

FIG. 3 is an example block diagram of the direct correspondents of a computer system. In FIG. 3, five computer systems A-E are represented by the circles. The lines represent the paths of the relationships (relationship paths) between applications and/or users of the various computer systems. Computer system A is shown having a direct relationship path to each of computer systems B, C, D, and E. Thus, computer systems B, C, D, and E (and their applications and users) are the direct correspondents of computer system A (and its applications and users).

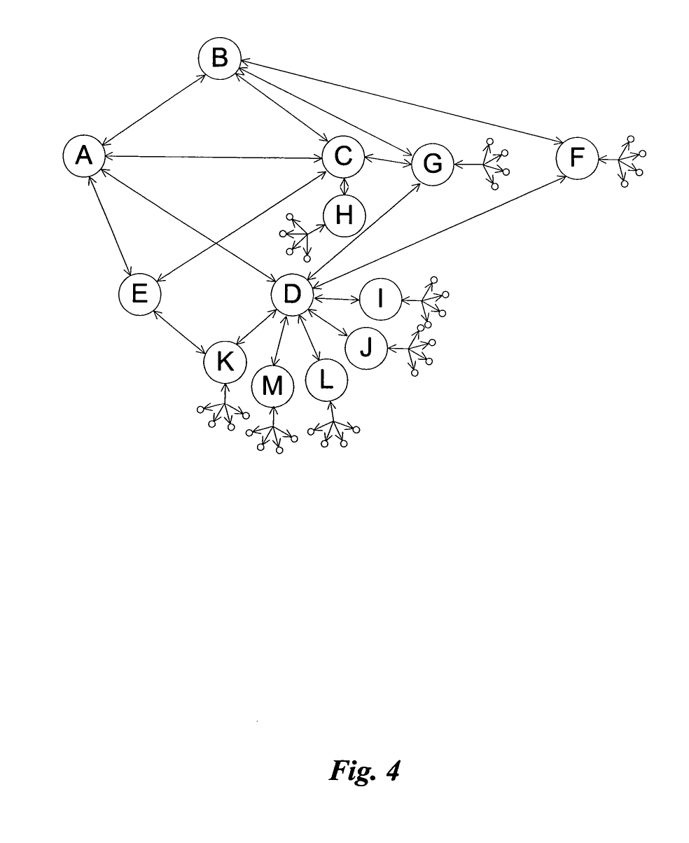

FIG. 4 is an example block diagram of a community of correspondents of a computer system that includes direct and indirect correspondents. Computer system A is shown (as in FIG. 3) as having a relationship path to direct correspondents B, C, D, and E. In addition, many of the direct correspondents of computer system A have their own direct correspondents, which, in turn, are indirect correspondents of computer system A. FIG. 4 shows three such levels of correspondents. For example, computer system D has seven additional direct correspondents, G, F, I, J, L, M, and K, which are also considered indirect correspondents of computer system A. Each of the computer systems G, F, I, J, L, M, and K is shown in turn as having direct correspondents (circles that are not labeled), which are indirect correspondents of both computer system D (through one level of indirection) and computer system A (through two levels of indirection).

According to an example PPDS, indirect correspondents are tracked by each member computer system to a user-settable (or predetermined) level. For example, if the tracking level for computer system A is set to three, then computer system A will track network address information for (1) its own direct correspondents (first level correspondents); (2) direct correspondents of computer system A's direct correspondents, which are computer system A's second level correspondents (related through one level of indirection); and (3) first level indirect correspondents of computer system A's direct correspondents, which are computer system A's third level correspondents (related through two levels of indirection).

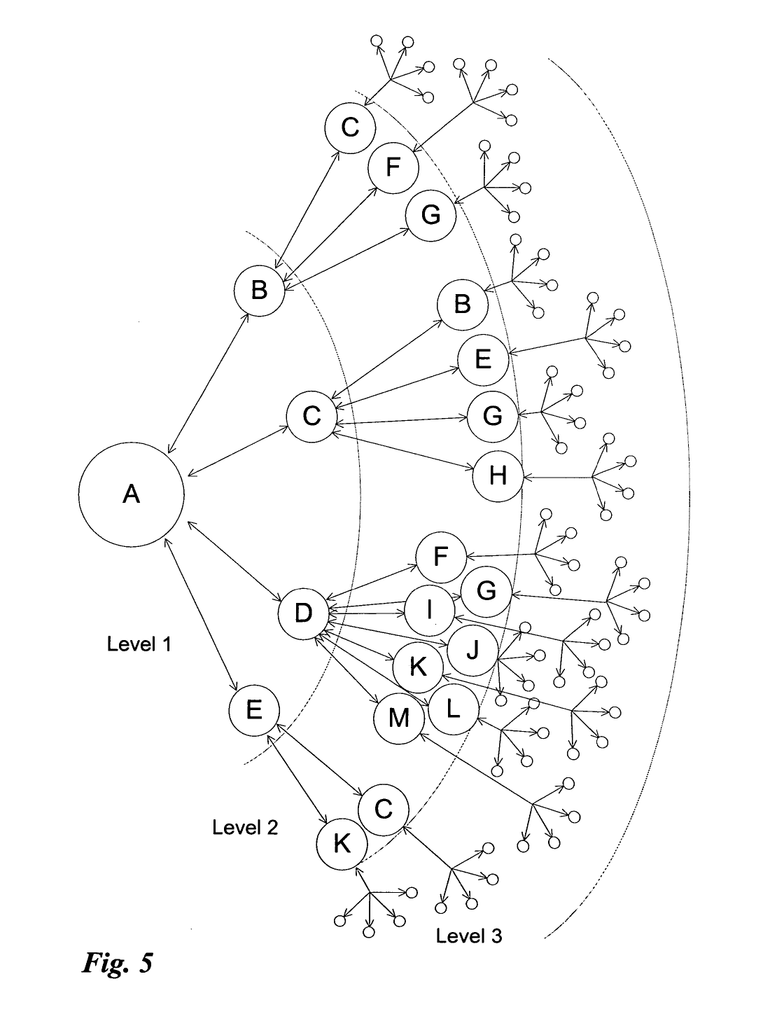

FIG. 5 is an example block diagram of the same community of correspondents shown in FIG. 4, but as discrete hierarchical levels of correspondents. In FIG. 5, the computer systems are designated by their level relative to computer system A. Specifically, the computer systems that are direct correspondents of computer system A are designated as level 1 correspondents, those that are direct correspondents of computer system A's direct correspondents are designated as level 2 correspondents, and those that first level indirect correspondents of the direct correspondents of computer system A are designated as level 3 correspondents, and so on. Note that many of the relationships are overlapping, which has no adverse effect on the PPDS. For example, although computer system C is a first level indirect correspondent of computer system A, it is also a direct correspondent of computer system A. Duplicative updates of tracked network addresses can simply be ignored.

Each computer system has its own tracking level, and is responsible for collecting and forwarding network address information as appropriate by level. (Each computer system typically forwards to one level less than it collects.) In one embodiment, tracking entails collecting network address information up through the tracking level number of correspondents; forwarding as appropriate received updates for these correspondents or information on new correspondents to one's own direct correspondents; and forwarding as appropriate updates regarding one's own network address to one's own correspondents. Typically, an effective date and time, or other indication of time period, is forwarded with each new or updated network address so that a receiving computer system can determine whether the address is more recent than one that is already stored.

In one embodiment, the PPDS presents a user interface to allow a user of the member computer system to change the default tracking level for that system. Thus, it is possible that different member computer systems are tracking to different levels of correspondents. Therefore, a member computer system may receive more or less network address information than it is set up to track, and it will simply ignore any excess information. The effective number of levels that the overall PPDS community operates with may thus be less than that chosen by a particular user. One skilled in the art will recognize that a default may be set to any number or for each system or for the community, and that the number of tracking levels could also be predetermined or arranged by users in advance.

In the example PPDS community 100 shown in FIG. 1, computer systems 101 and 102 are direct correspondents, as shown by a line 130 that represents a direct relationship path, through an application running on the computer system 101 that communicates (or is otherwise associated with) an application running on computer system 102. For example, computer system 101 may be running a peer-to-peer application that communicates with computer system 102 and thus “knows of” computer system 102. One such application is a METHOD AND SYSTEM FOR RECIPROCAL DATA BACKUP, described in U.S. patent application Ser. No. 10/838,293, which is incorporated herein by reference in its entirety. Similarly, computer system 104 is a direct correspondent of computer system 102, as shown by the direct relationship path line 131, and thus is an indirect (second level) correspondent of computer system 101. Further, computer system 103 is a direct correspondent of computer system 104, as shown by direct relationship path line 132, and thus is an indirect (second level) correspondent of computer system 102 (through computer system 104) and an indirect (third level) correspondent of computer system 101 through two levels of indirection (through computer system 104 and then through computer system 102).

For the purposes of the PPDS, 104 and 103 are indirect correspondents of computer system 101, even though computer system 101 may have no a priori knowledge of either system. Potentially unbeknownst to the users and applications of computer system 101, the PPDS portion 111 that executes on computer system 101 becomes “knowledgeable” of computer systems 103 and 104 through running the PPDS. Specifically, according to the techniques described herein, at some point the PPDS tracking and location service 112 on computer system 102 informs the PPDS tracking and location service 111 of the networking addresses of systems 103 and 104 as correspondents of computer system 102. (Alternatively, computer system 101 may learn of these computer systems through other means, such as through a different direct correspondent.) The PPDS tracking and location service 111 running on computer system 101 uses the respective PPDS tracking and location services 113 and 114 on computer systems 103 and 104 (computer system 101's indirect correspondents) to find a current network address of computer system 102 when computer system 102 becomes “unavailable” from the perspective of computer system 101. This scenario might occur if, for example, computer system 102 is off-line, and then comes on-line with a new address during a time when computer system 101 is off-line, so that computer system 102 cannot contact 101 with its new address. Later when computer system 101 comes on-line perhaps with its own new address, the address that computer system 101 has stored for computer system 102 is no longer valid (because computer system 102's address has changed) and if computer system 101's address has also changed, then computer system 102 no longer has the correct address for computer system 101, so neither system has a current (working) address of the other. To obtain computer system 102's current address, the PPDS tracking and location service 111 running on computer system 101 uses stored network address information to contact computer systems 103 and 104 as needed to request a current address for computer system 102. As long as at least one of computer systems 103 and 104 was on-line when computer system 102 obtained its new address (or, in another embodiment, computer 104 was on-line and forwarded it to its correspondents), then the address of computer system 102 will be discoverable by the PPDS.

In general, to find a target correspondent's current network address when the target correspondent cannot be contacted, the PPDS tracking and location service of a resident member computer system queries its other correspondents, which include a target correspondent's correspondents, for the target's current address. Several techniques can be used to query the other correspondents for the target correspondent's current address. One technique focuses on contacting correspondents based upon current tracking information stored in the resident computer system's data repository. Direct and indirect correspondents are queried until a working address is found. A second technique focuses on spreading the location task between correspondents. According to this technique, the resident computer system queries its direct correspondents, and, if these other correspondents cannot be contacted, then the PPDS tracking and location service on the resident computer system contacts their correspondents in turn in an effort to find the other direct correspondents' current network addresses, and then querying them for the target correspondent's address, and so on. This process is repeated as necessary for as many levels of correspondent information that are maintained by the PPDS tracking and location service, until one such sequence of correspondents is able to return a current network address for the target correspondent or until all correspondents have been exhausted. Other techniques, or variations of these techniques are also possible. Once the target correspondent's current network address has been determined using any of these techniques, then the resident computer system may send the target correspondent its own network address information to ensure that further communication can easily occur.

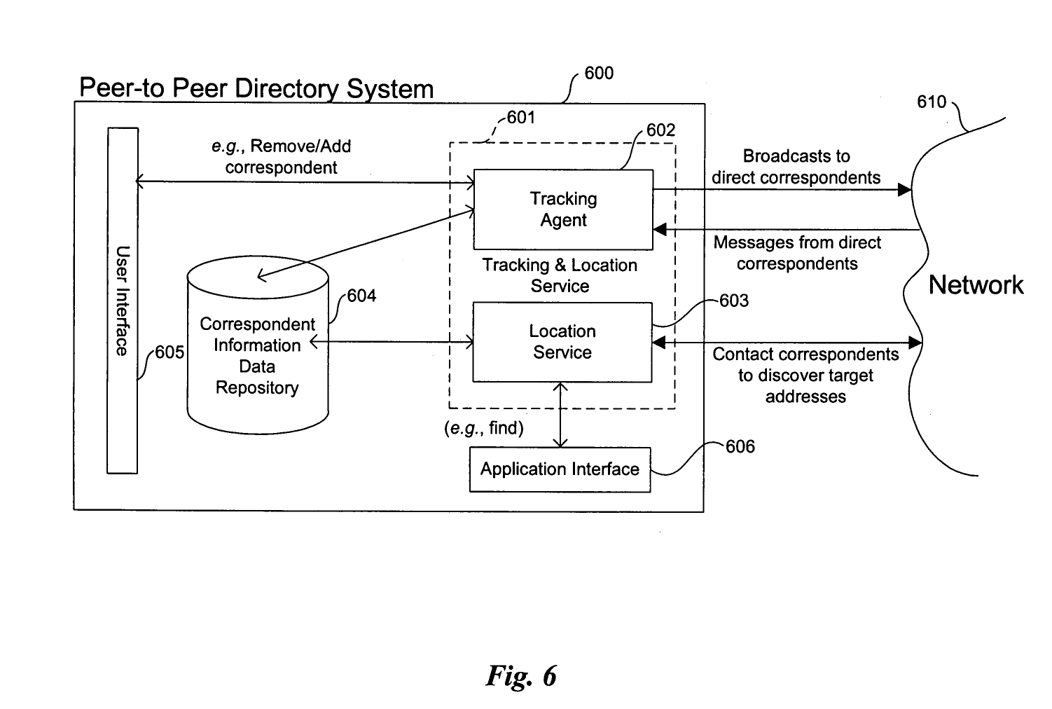

FIG. 6 is an example block diagram of components of an example peer-to-peer directory service portion executed by each member computer system. In one embodiment, the peer-to-peer directory service comprises one or more functional components/modules that work together to provide correspondent tracking and location. One skilled in the art will recognize that these components may be implemented in software or hardware or a combination of both. In FIG. 6, a PPDS portion 600 comprises tracking and location service 601, which includes a tracking agent 602 and a location service 603; a correspondent information data repository 604; a user interface 605; and an application interface 606. The tracking agent 602 forwards (e.g., broadcasts or transmits) changes to its own computer system's network address, and potentially network address information for the tracking level number of correspondents to its direct correspondents via network 610, and receives similar messages from its direct correspondents via network 610. The tracking agent 602 stores received network addresses and network address information in the correspondent information data repository 604. The location service 603 uses network 610 and network addresses retrieved from the data repository 604 to contact correspondent computer systems to automatically determine a network address for a target correspondent computer system. The user interface 605 allows users to adjust setup features of the PPDS including setting a correspondent tracking level and manual entry of direct correspondent's network addresses. It also allows users to remove a direct correspondent and thus prevent the PPDS from further tracking of that correspondent. The application interface 606 allows applications to invoke the location service 603 to find a network address of a target correspondent, to programmatically enter network addresses of direct correspondents, to specify a particular direct correspondent to track, to update a network address of a direct correspondent, to remove a direct correspondent from being tracked, to set a tracking level, and other similar functions.

Although the techniques of automatic peer-to-peer tracking and locating and the PPDS are generally applicable to any type of network address, the phrase “address,” “url,” “network address,” etc., is used generally to imply any type of location identifier of another system. In addition, one skilled in the art will recognize that the network addresses are really “black boxes” to the Peer-to-Peer Directory System, the content of which need not be understood—just stored, retrieved, and forwarded by the PPDS portions. Thus, the techniques described herein can be applied to a heterogeneous mixture of wide area network addresses and private local area network addresses as well as to systems with homogeneous addresses. In the case of multiple machines sharing a single public address (as often occurs with networked home computers), the address information stored and transmitted may include additional fields to identify a particular computer on a private network.

Also, although the examples described herein often refer to peer-to-peer applications, one skilled in the art will recognize that the techniques of the present invention can also be used by systems that employ traditional applications that communicate by means of an intermediary system or using a client-server model exclusively or in addition to peer-to-peer applications. In such a scenario, the PPDS doesn't change the flow of normal application communication, although it utilizes peer-to-peer techniques to locate the other systems involved in the communications. Essentially, the concepts and techniques described are applicable to any group of computer systems that desires to share addressing whether or not they utilize peer-to-peer applications at all, in-part, or in whole.

Also, although certain terms are used primarily herein, one skilled in the art will recognize that other terms could be used interchangeably to yield equivalent embodiments and examples. For example, it is well-known that equivalent terms could be substituted for such terms as “community,” “correspondent,” “member,” etc. Specifically, the term “community” can be used interchangeably with “group,” “set,” “plurality of,” etc. Likewise, the term “correspondent” can be used interchangeably with the terms “communication recipient,” etc. Also, the terms broadcast and forward are not intended to imply a particular implementation of any underlying communications primitives. In addition, terms may have alternate spellings which may or may not be explicitly mentioned, and one skilled in the art will recognize that all such variations of terms are intended to be included.

Example embodiments described herein provide applications, tools, data structures and other support to implement a Peer-to-Peer Directory System to be used for automatically tracking and locating correspondent computer systems. In the following description, numerous specific details are set forth, such as data formats and code sequences, etc., in order to provide a thorough understanding of the techniques of the methods and systems of the present invention. One skilled in the art will recognize, however, that the present invention also can be practiced without some of the specific details described herein, or with other specific details, such as changes with respect to the ordering of the code flow.

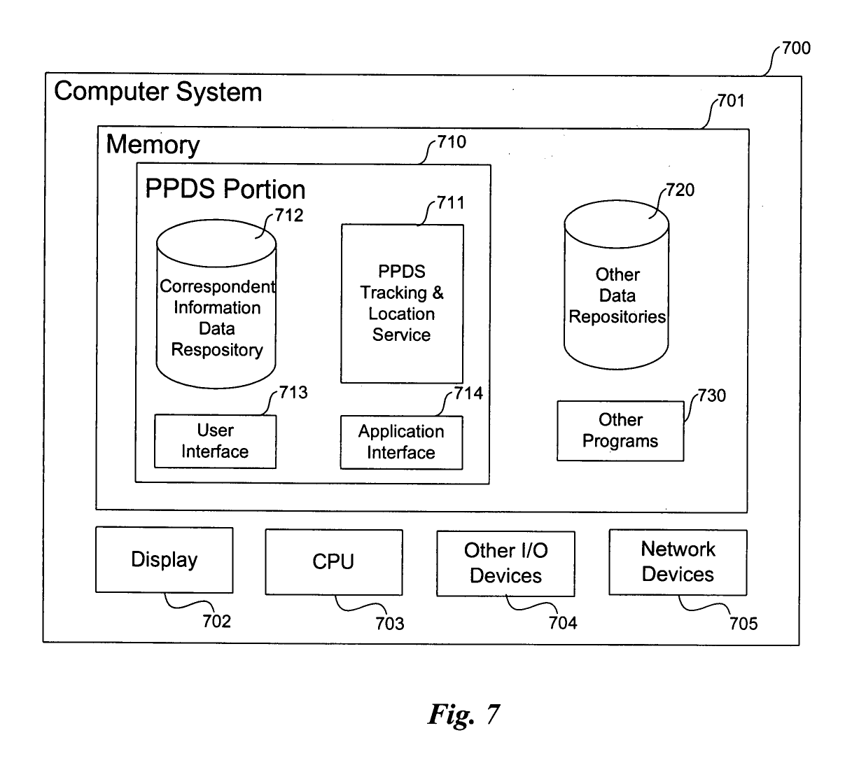

FIG. 7 is an example block diagram of a general purpose computer system for practicing embodiments of a peer-to-peer directory service portion. Each portion that comprises the peer-to-peer directory service executes on one or more of such computer systems. Moreover, the general purpose computer system 700 may comprise one or more server and/or client and/or peer computing systems and may span distributed locations. In addition, each block shown may represent one or more such blocks as appropriate to a specific embodiment or may be combined with other blocks. Also, the various blocks of the peer-to-peer directory system portion 710 may physically reside on one or more machines, which use standard interprocess communication mechanisms to communicate with each other.

In the embodiment shown, computer system 700 comprises a computer memory (“memory”) 701, a display 702, a Central Processing Unit (“CPU”) 703, Input/Output devices 704, and network devices 705. The components of the Peer-to-Peer Directory System portion 710 are shown residing in memory 701. (The memory 701 includes any type of computer memory including RAM, ROM, and persistent storage such as disk drives.) The components of the PPDS portion 710 preferably execute on CPU 703 and perform tracking and locating functions, as described in previous figures. Other downloaded code 730 and potentially other data repositories, such as repository 720, also reside in the memory 701, and preferably execute on one or more CPU's 703. In a typical embodiment, the PPDS portion 710 includes a tracking and location service 711, the correspondent information data repository 712, the application interface 714 and the user interface 713. One skilled in the art will recognize that many different arrangements of the components of the PPDS portion 710 are possible.

In an example embodiment, components of the PPDS portion 710 are implemented using standard programming techniques. One skilled in the art will recognize that various object-oriented and distributed methodologies may be used. However, any of the PPDS portion components 711-714 may be implemented using more monolithic programming techniques as well. In addition, programming interfaces to the data stored in the correspondent information data repository 712 or the functions of the tracking and location service 711 can be made available by standard means such as through C, C++, C#, and Java API and through scripting or tag-based languages such as JavaScript or XML, or through web servers supporting such. The correspondent information data repository 712 that is used to store network address information is preferably implemented for scalability reasons as one or more databases rather than as a text files. However, any method for storing such information may be used. In addition, portions of the tracking and location service 711 may be implemented as stored procedures, or methods attached to stored “objects,” although other techniques are equally effective.

One skilled in the art will recognize that the PPDS including the PPDS portions 710 may be implemented in a distributed environment that is comprised of multiple, even heterogeneous, computer systems and networks. For example, in one embodiment, the PPDS tracking and location service 711, the correspondent information data repository 712, the user interface 713, and the application interface 714 are all located in physically different computer systems. In another embodiment, various components of the PPDS portion 710 are hosted each on a separate server machine and may be remotely located from the correspondent network address information which is stored in the correspondent information data repository 712. Different configurations and locations of programs and data are contemplated for use with techniques of the present invention. In example embodiments, these components may execute concurrently and asynchronously; thus the components may communicate using well-known message passing techniques. One skilled in the art will recognize that equivalent synchronous embodiments are also supported by an PPDS implementation. Also, other steps could be implemented for each routine, and in different orders, and in different routines, yet still achieve the functions of the PPDS.

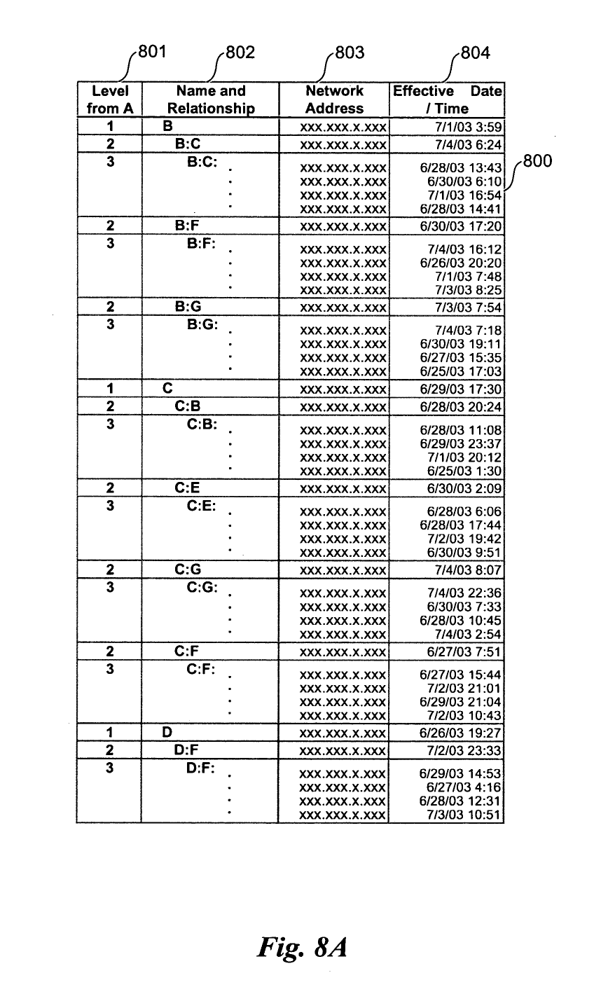

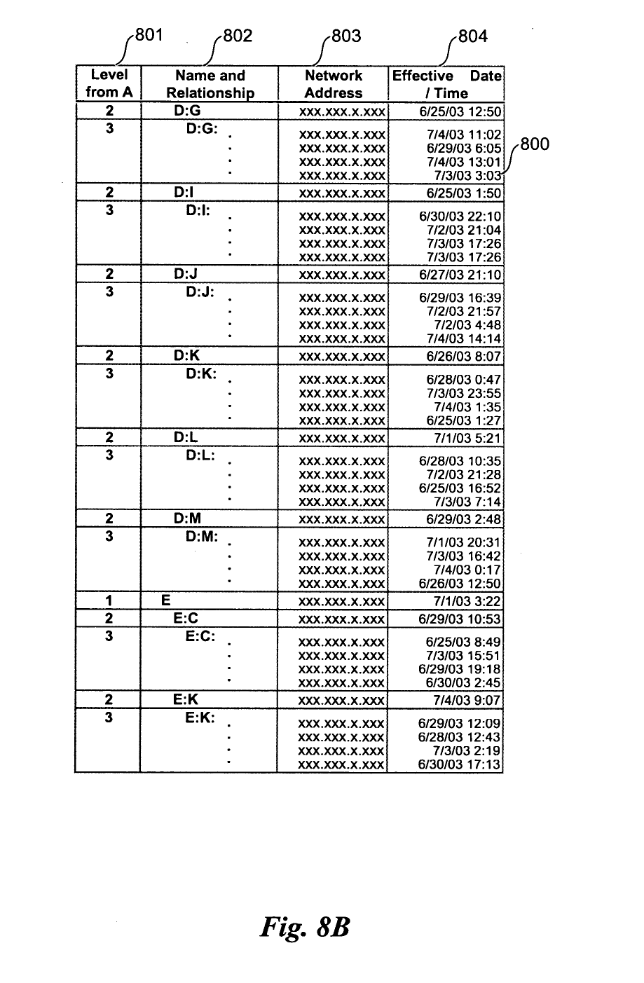

As mentioned, in order for the PPDS to provide automated tracking and locating of correspondents, each member computer system of a community is responsible for storing network address information associated with each of its correspondents, up to the designated tracking level for that computer system. FIGS. 8A and 8B are an example block diagrams of the correspondent information of a Peer-to-Peer Directory Service stored in a data repository. This information is stored for example in the correspondent information data repository 604 in FIG. 6. Correspondent information 800 includes a plurality of entries, each of which corresponds to a particular correspondent relative to the member computer system. The example entries shown in FIGS. 8A and 8B correspond to the community of member computer systems illustrated in FIG. 5.

Specifically, each entry includes several fields that provide tracking data for a particular direct or indirect correspondent. Field 801 is an indication of its tracking level relative to the member computer system. Field 802 is a representation of the name of the correspondent and its relationship path relative to the member computer system. It includes a representation of the correspondent's relationship path starting from the direct correspondent that is associated with the member computer system when the correspondent is an indirect correspondent. Each component of the path is an indicator of a member computer system; thus, two components in sequence indicates a direct correspondent relationship between them. The relationship path stored in field 802 allows the PPDS location service to contact the appropriate indirect correspondents when the PPDS is attempting to determine a network address for an associated direct correspondent. For convenience, a relationship path between computer systems A and C (though B) is designated as “A→B→C” or “A:B:C,” where A, B, and C are indicators of their respective computer systems. One skilled in the art will recognize that any nomenclature that can be used to describe the direct and indirect relationships can be used with and incorporated into the techniques of the present invention and that many different indicators of computer systems can be used. Field 803 is a representation of an associated (the last known) network address 803 of the correspondent named in field 802. Field 804 is an indication of the effective date and time of the address stored as associated network address 803. One skilled in the art will recognize that many alternative representations of the network information are possible and that other information may be stored in the data repository.

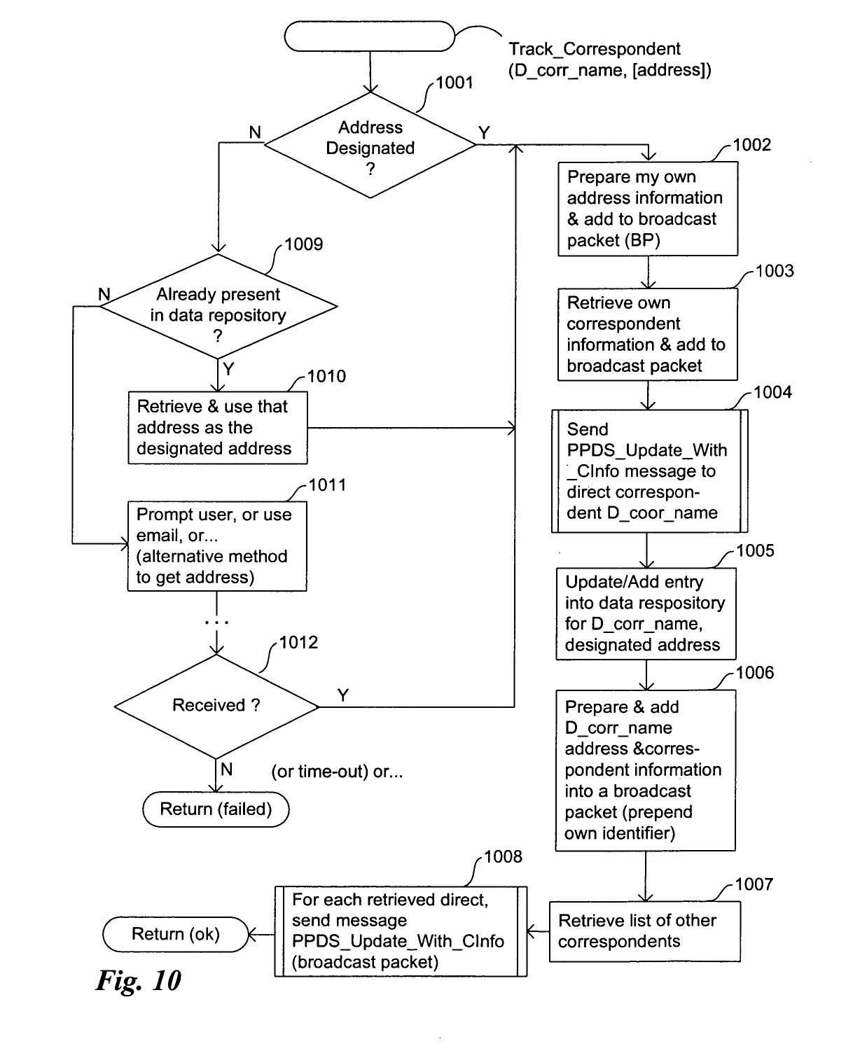

Although the information stored in the correspondent information data repository is updated on a periodic basis by each member computer system based upon receiving updated address information, initial correspondent information is needed to bootstrap the entire tracking and locating process. Specifically, in one embodiment when a PPDS portion is first installed (and executed) on a member computer system, it creates and initializes the correspondent information data repository with initial network addresses values for at least some of the direct correspondents of the member computer system. (In other embodiments, the data repository may not be created or initialized until a first use is attempted, or at some other time.) In one embodiment, the PPDS locates potential direct correspondents, which may be approved or disapproved by a user prior to entry into the data repository. These initial direct correspondents are “new” to the system and will trigger the automatic update process as if information for a new direct correspondent information was just received by an application running on the member computer system. A new direct correspondent can also be added (upon PPDS initialization or at other times) by an application invoking a routine (of the application interface) to track a new direct correspondent. A routine for handling network address information updates for a new direct correspondent is described below with reference to FIG. 10.

There are several ways that correspondent information can be entered initially into the PPDS data repository of a resident member computer system. In any one embodiment, one or more of these methods may be used. One method is for the PPDS upon installation to examine correspondent information that may be stored, for example, in system registries, buddy lists, email address books, etc., for existing peer-to-peer applications and other communication facilities to create a list of potential correspondents. The user may be offered an opportunity to accept or reject any found potential correspondents and enter or verify corresponding network addresses. Another method is for the PPDS to present its own user interface to allow the user to add additional direct correspondents (and their network information) as desired. This method may be invoked, for example, upon installation of the PPDS and explicitly by the user anytime the user desires to add a direct correspondent. A third method is for an application to invoke an application programming interface (“API”) of the PPDS to track a new direct correspondent.

When a direct correspondent is added to the data repository (automatically by the PPDS upon initialization or by a user or by an application) if an associated network address is not known, then several techniques can be employed to determine a current network address. First, the PPDS can examine entries in the correspondent information data repository to determine whether the direct correspondent is already present in the data repository as an indirect correspondent, and, if so, an initial network address is retrieved from the determined entry. While there is not necessarily an engineered reason why this scenario would exist, in practice, correspondents will come from communities with a lot of overlap among correspondents and so a new correspondent for one user may very well already be a correspondent of one of that user's existing other correspondents. Second, if a correspondent's email is known, but an associated network address is not, then the PPDS can send an email message to the potential correspondent that includes the member computer system's current network address and requests a return network message with a current network address. When the new address is received, it is then entered into the correspondent information data repository.

FIG. 9 is an example block diagram of a method for using email to obtain a network address for a correspondent. In FIG. 9, the PPDS portion 902 running on member computer system 901 desires to locate a current network address for target member computer system 903. The PPDS portion 902 sends an email message 904 on network 905 addressed to the email address of computer system 903 containing its own network address (the address of computer system 901) and requesting a return network message. The email messages 904 travels through a standard email server system 910 using well-known interfaces and protocols and is (eventually) retrieved by computer system 903 during its normal course of email processing. The PPDS portion 906 running on member computer system 903 examines the message 904, retrieves the address of computer system 901 from the email message 904, and prepares a network message 907 to be sent back to computer system 901. In some embodiments, the computer system 903 automatically sends the network message 907 to computer system 901, for example, when the email comes from a user that users on computer system 903 have “pre-approved” (e.g., have a standing relationship), or the PPDS first queries the user of computer 903 to determine whether to send the return network message 907. The network message 907 contains the address of computer system 903, so that computer systems 901 and 903 can thereafter communicate. The PPDS portion 902 receives the message 907 and updates its correspondent information data repository with the network address of target member computer system 903.

When the PPDS portion itself or an application indicates that a new direct correspondent is to be tracked, as part of initializing the PPDS portion or thereafter, the PPDS portion invokes a routine to broadcast the network address and potential correspondent information for the new direct correspondent to its other direct correspondents. In addition, in some embodiments, the routine may send to each new direct correspondent, the resident system's own network address and its correspondent network address information. In other embodiments, this information may be sent to the new direct correspondent through another routine or message, or at some other time.

Other events in the PPDS portion may also cause a member computer system's network address or correspondent information to be forwarded or broadcasted. One such event occurs each time a member computer system is given its own new network address (an updated address). In one embodiment, each time a member computer system receives a new network address, it broadcasts the new network address to its direct and indirect correspondents, for which there are entries in its data repository. These entries are typically set up when correspondents were added for tracking as described above. In this embodiment, there is no need to propagate the updates, because the broadcast will result in informing those correspondent computer systems that are on-line and available. In another embodiment, each time a member computer system is given its own new network address, it broadcasts the new network address to its direct correspondents, which then propagate the network address to their direct correspondents, and so on, for the tracked number of levels. Another event that potentially causes a network address or correspondent information to be forwarded or broadcasted occurs whenever the PPDS portion or an application receives a request to end tracking of a direct correspondent. An indication of the direct correspondent to be eliminated from tracking is propagated throughout paths of direct correspondents so that the direct correspondent and its correspondent information can be eliminated from each member system.

The figures that follow address the various routines and messages that may occur in response to such events. One skilled in the art will understand that, although particular messages and message names are referred to for convenience in many of the routines that follow, other messages, ordering of messages, functions etc., may be equivalently incorporated into the techniques described herein. In addition, although the routines and message handlers operate to track and store direct and indirect correspondent information, embodiments of the PPDS are envisioned that only track direct correspondent information or indirect correspondents to a single level of indirection. (For example, computer A adds a new direct correspondent to track, computer X, and informs its other direct correspondents of computer X, but the information is not propagated further.)

FIG. 10 is an example flow diagram of a PPDS routine to track a new direct correspondent. This routine is invoked when a new direct correspondent is indicated to a resident member computer system, for example, during the initialization process upon a user approving the addition of a potential direct correspondent. (The resident computer system is the computer system that is running the PPDS portion referred to.) It can also be invoked by a peer-to-peer application running on the resident computer system to explicitly indicate that the application desires a particular direct correspondent to be tracked by the PPDS. In that case, the peer-to-peer application indicates to the PPDS portion (through, for example, application interface 606 in FIG. 6) the name of a direct correspondent and its current network address, if known, as designated parameters.

Specifically, in step 1001, the routine determines whether an address has been designated as a parameter, and, if so, continues in step 1002, else continues in step 1009. In step 1002, the routine prepares the address of the resident computer system (and an effective date and time) into a packet for broadcasting to the named direct correspondent. In step 1003, the routine retrieves the resident computer system's correspondent information from the correspondent information data repository and adds the retrieved information into the broadcast packet. In step 1004, the routine sends a PPDS_Update_With_CInfo message with the prepared information stored in the broadcast packet to the designated direct correspondent. Note that although the routine is described as transmitting both the resident computer network address and the network address information of its correspondents all at one time (in one packet), one skilled in the art will recognize that some or all of this information may be transmitted at any one time or in multiple packets at different times or at the same time, or not at all etc. In step 1005, the routine updates an existing entry or adds a new entry into the data repository that corresponds to the designated direct correspondent and its address, along with an effective date and time. In step 1006, the routine prepares address information for the designated direct correspondent including the effective date and time and any correspondent information for the designated direct correspondent into a (freshly initialized or new) broadcast packet. In a typical embodiment, the preparation step involves prepending (appending to the beginning) an indication of the resident computer system to each relationship path of each correspondent that is passed in the broadcast packet. For example, before computer system A sends information on a new correspondent computer system X, it prepends an “A” to each relationship path. What was previously a path designated “X→C” now becomes “A→X→C” before being sent to computer system A's other direct correspondents, so that the receiving correspondent knows that contact to computer system X is through computer system A. One skilled in the art will recognize that other mechanisms for prepending an indication of the resident computer system to a relationship path are available, including letting a message recipient computer system prepend an indicator of the source correspondent of a received message to a path before using it. In step 1007, the routine determines a list of other direct correspondents from the data repository. In step 1008, the routine sends a “PPDS_Update_With_CInfo” message to each of the other direct correspondents with the broadcast packet containing the new direct correspondent's information, and then returns.

In step 1009, if no address has been designated, then before steps 1002-1008 can be executed, the routine needs to determine whether it has or can obtain a working address by some other means. For example, in step 1009, the routine searches the data repository to determine whether the designated direct correspondent is already in the data repository either as a direct correspondent already or as an indirect correspondent of some other direct correspondent as described earlier. If so, then in step 1010, the routine retrieves the determined address and sets the designated address to the retrieved address, and then continues with steps 1002-1008. Otherwise, then the routine needs to invoke a more manual means if one is available. For example, in some embodiments as described above, in step 1011 the routine prompts a user to enter an address for the designated correspondent, and then determines in step 1012 if an address is received. If so, the routine continues in steps 1002-1008, otherwise the routine returns a failure code. In other embodiments, in step 1011, the routine uses an email message to send the direct correspondent the address of the resident system and requests a return network message to the resident address with the address of the designated direct correspondent. This technique was described with respect to FIG. 9 above.

Note that even though one (user or application of a) computer system specifies another (user or application of a) computer system as a direct correspondent, the relationship may not be reciprocal. That is, the second computer system may not consider the first a direct correspondent. This is not a harmful situation and in fact the first computer system may still get updated information for the second, providing that the computer systems have other member computer systems of the community in common. In addition, as mentioned previously there may be some overlap between correspondents. Even if a member computer system receives updates for a correspondent more than once, no harm is done providing the member computer system checks before updating the data repository to make sure that a received address is newer than one already stored before updating the stored address.

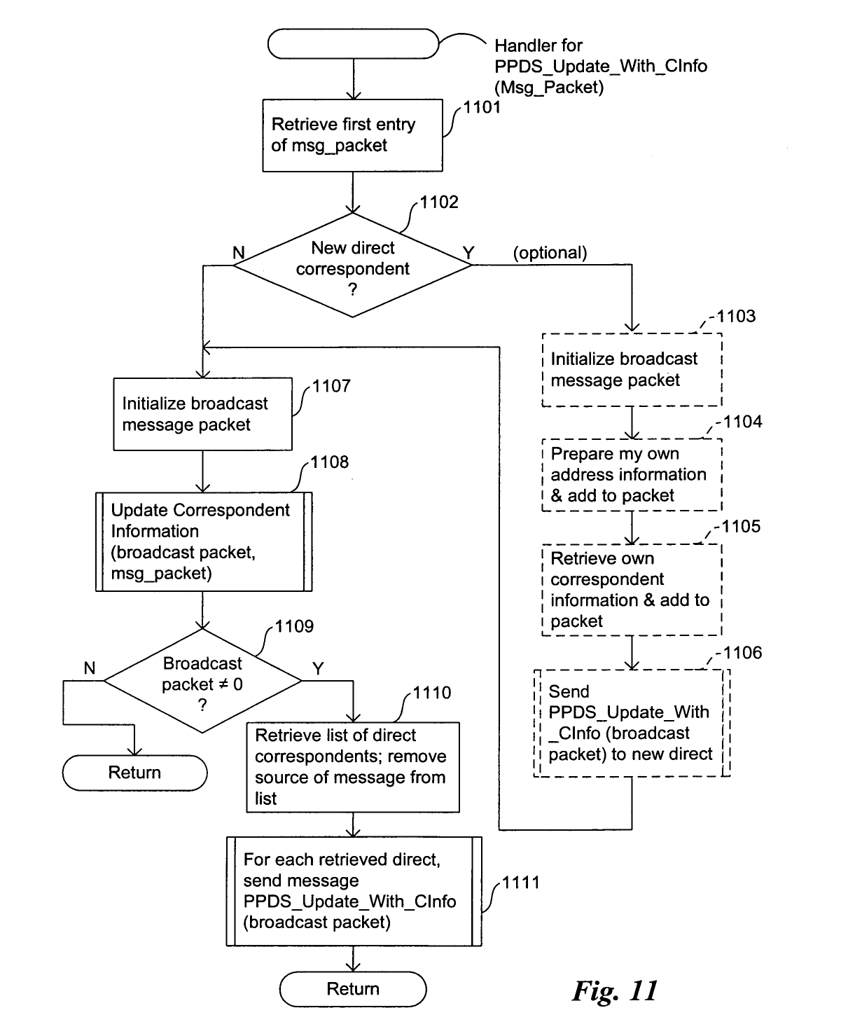

FIG. 11 is an example flow diagram of a routine executed by an example peer-to-peer directory system portion in response to receiving a network address tracking message to add a new correspondent. This routine is executed, for example, in response to a computer system receiving a PPDS_Update_With_CInfo message from one of its direct correspondents that the one of the direct correspondents has a new direct correspondent. For example, as described in step 1008 in FIG. 10, when a new direct correspondent is added to the PPDS to be tracked, the new direct correspondent's information (its address and potentially its correspondent information) is broadcast to its other direct correspondents. Thus, this message propagates the new correspondent and its correspondent info along the paths of direct correspondents of the community.

Although not necessarily a typical embodiment, it is possible that the PPDS_Update_With_CInfo message could also be invoked by an application running on a different computer system to track a new correspondent. Optional steps 1103-1106 may be thus included to process the new direct correspondent similar to how it would be handled if the request had come from the resident system (and called the routine that is described in FIG. 10). Specifically, in this case, it may be desirable for the message handler of the receiving system to first send all of its own computer system information to the new direct correspondent, update its own data repository, and then forward the received new direct correspondent information to the receiving system's direct correspondents.

In the embodiment shown, a message packet, which may include more than one entry of correspondent network address information, is designated as an input parameter. The message handler of the receiving system processes each entry in the message packet, and then propagates the entries (prepending the relationship paths with an indication of the receiving computer system) to all of its other direct correspondents. This process will trigger PPDS_Update_With_CInfo messages to be sent to each set of direct correspondents until the address of the newly tracked relationship is fully propagated through the tracking level. (Also, each receiving system will ignore received addresses that are not more recent than those already stored in its data repository.)

Specifically, in step 1101, the message handler for a PPDS_Update_With_CInfo retrieves the first entry of the message packet. Assuming that the handler is coded to be able to receive a request message to track a new direct correspondent as described above, then in step 1102, the handler determines whether the retrieve first entry specifies a new direct correspondent, and, if so, continues in step 1103, else continues in step 1107. In an embodiment that doesn't handle new direct correspondents in this fashion, steps 1102-1106 would be non-existent. In step 1103, the handler initializes a message packet for broadcasting. In step 1104, the handler prepares network address information of the resident computer system, including an effective date and time, and adds it to the message packet. In step 1105, the handler retrieves and prepares correspondent information for the resident computer system and adds it to the message packet. In step 1106, the handler sends a PPDS_Update_With_CInfo message to the designated direct correspondent passing the prepared message packet and continues in step 1107.

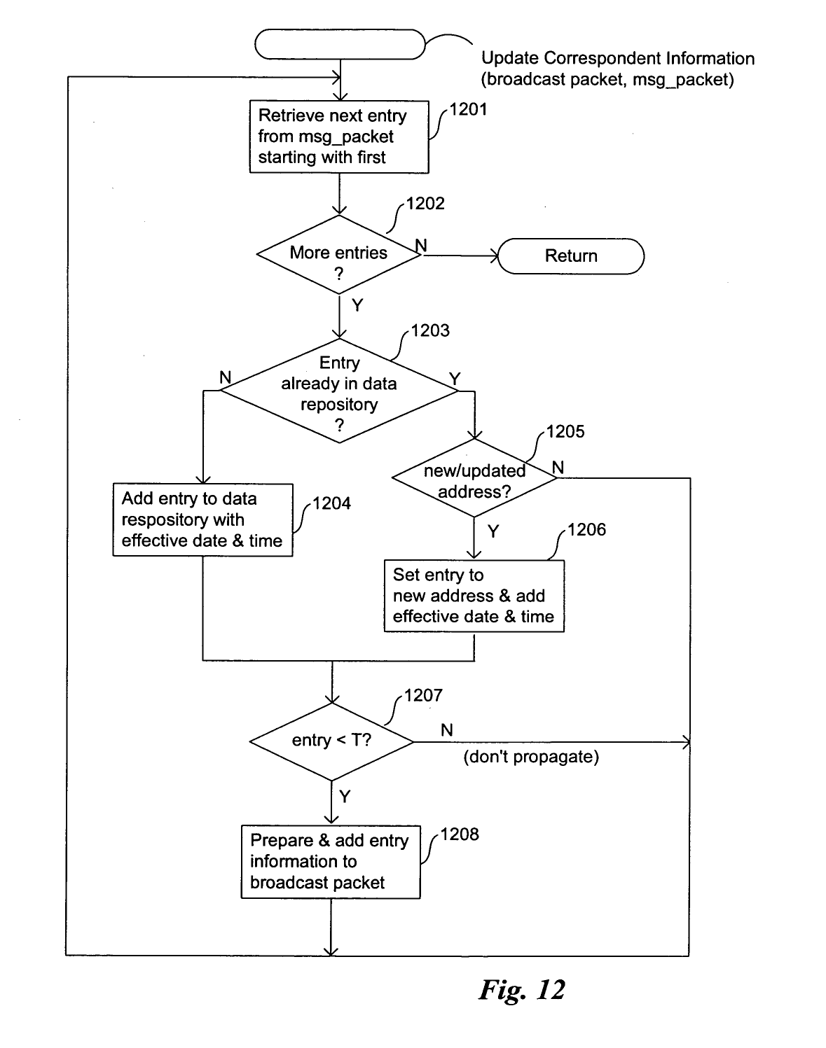

In step 1107, consistent with normal use of this routine in sequence with the Track New Correspondent routine of FIG. 10, the routine initializes a broadcast message packet. In step 1108, the routine invokes another routine to update the correspondent information data repository for each entry in the designated message packet passing the designated network address information message packet, and the newly initialized broadcast message packet. This routine is described further below with respect to FIG. 12. Once the data repository is updated with the received network address information (for one or more levels of correspondents), the handler in step 1109 determines whether the broadcast message packet has information to be forwarded, and, if so, continues in step 1110 to initiate propagation, else returns. In step 1110, the handler retrieves a list of the direct correspondents from the data repository. In step 1111, for each direct correspondent in the retrieved list that is not the direct correspondent that sent the current PPDS_Update_With_CInfo message, the handler sends an PPDS_Update_With_CInfo message with the broadcast message packet to propagate the information.

FIG. 12 is an example flow diagram of a routine executed by an example peer-to-peer directory system portion for updating or adding correspondent information to a correspondent information data repository. The routine receives a designated update message packet with network address information to be potentially stored in the data repository and a newly initialized broadcast message packet to be used for further propagation if necessary. In step 1201, the routine retrieves the next entry of the designated update message packet starting with the first. In step 1202, the routine determines whether there are more entries, and, if so, continues in step 1203, else returns. In step 1203, the routine determines whether the correspondent name field in the retrieved entry designates an already existing data repository correspondent with the designated relationship path, and, if so, continues in step 1205, other continues in step 1204. In step 1204, the routine adds a new data repository entry for the new correspondent, and continues in step 1207 to determine whether to propagate the entry. In step 1205, the routine determines whether the entry update is newer address than previously recorded. One way to determine whether the address is new is to compare date and time associated with the received address against the associated date and time of the retrieved address, and, if the received is older or the same, then to ignore the received data. In step 1206, the routine updates the data repository with the new/updated address information (and effective date and time). In step 1207, the routine determines whether to propagate the entry, which is based upon whether the entry is at the tracking level maximum, or whether tracking is being performed to more levels. If so, then the routine continues in step 1208 to prepare and add an entry for the new or updated correspondent into the broadcast message. The preparation step typically includes prepending an indication of the resident computer system to the relationship path of the entry that is passed in the broadcast packet. The routine then returns to process the next received entry of the update message packet in step 1201. Once all received correspondent entries have been processed in step 1202, the routine returns with either the broadcast message packet containing information for further propagation or empty.

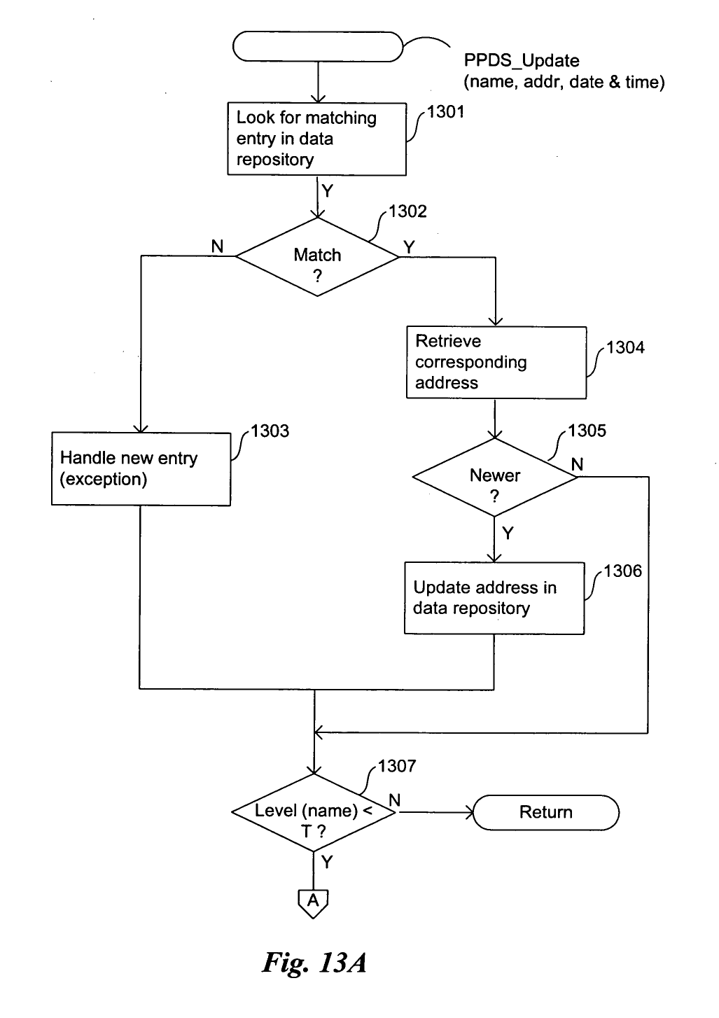

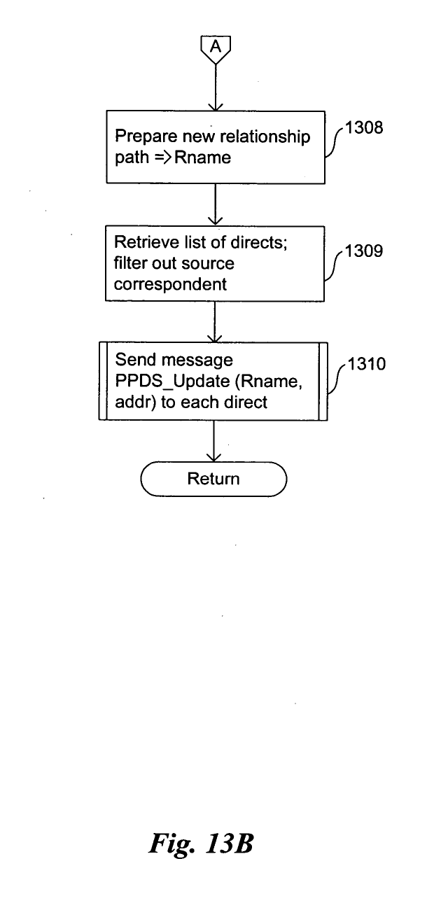

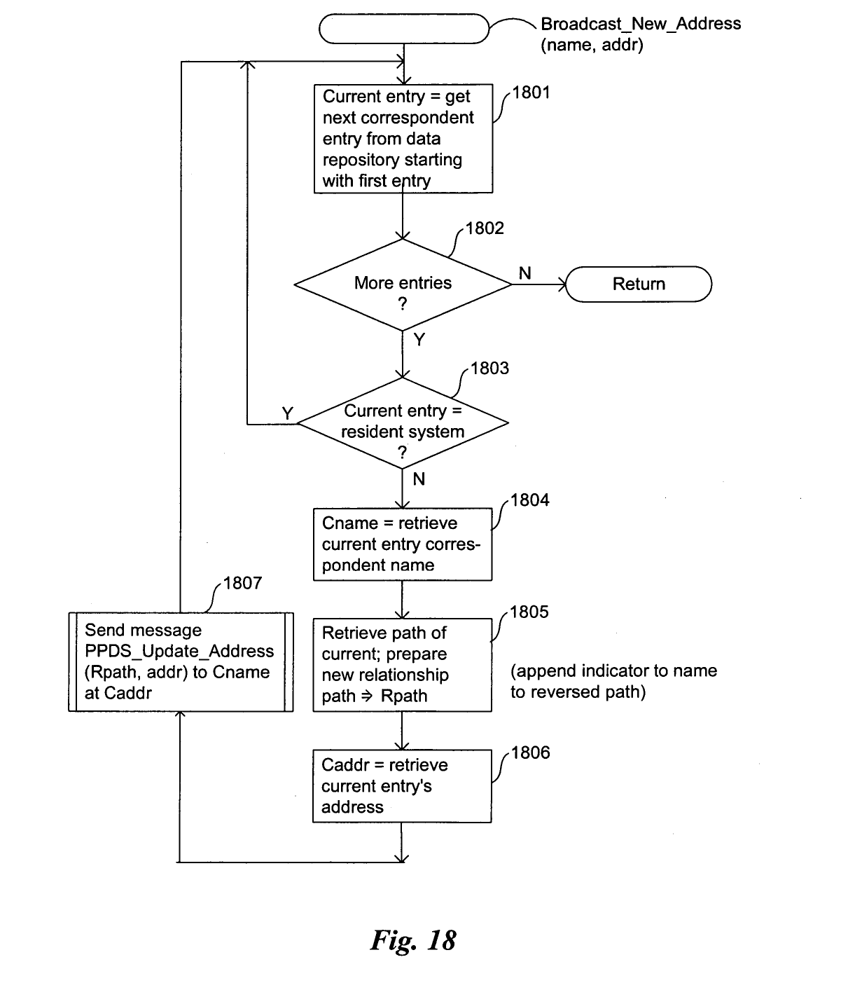

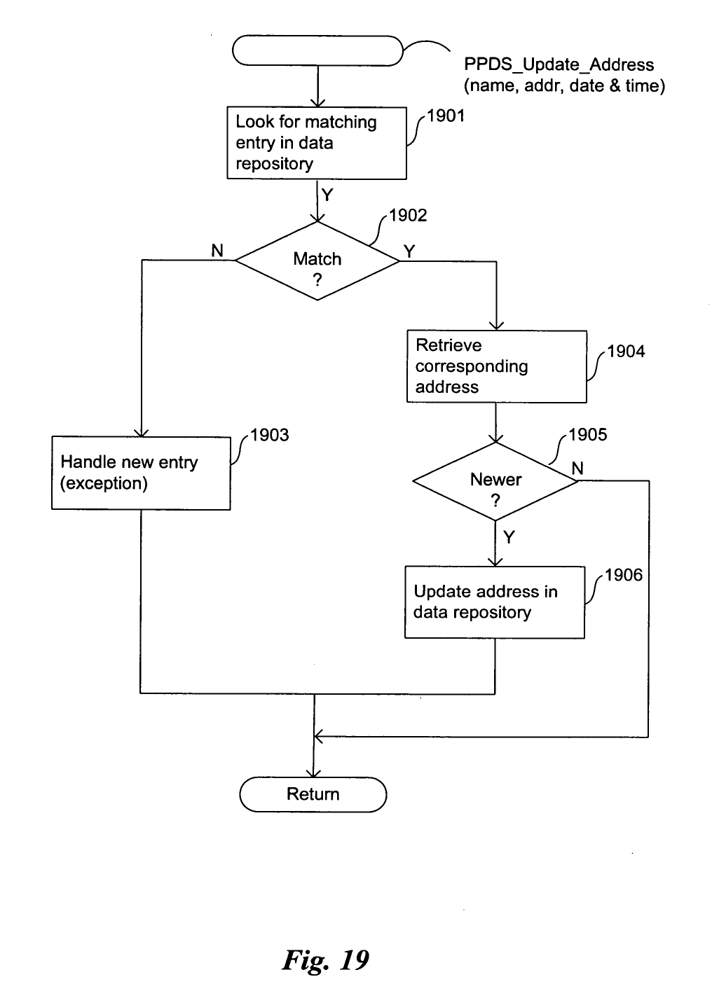

In general, FIGS. 10, 11, and 12 are invoked when a new direct correspondent is requested to be tracked by a member computer system. At this time, it is convenient (although not necessary) to send to the new direct correspondent the network address and correspondent information of the resident computer system. One skilled in the art will recognize that there may be other advantageous times for a resident member computer system to send updates to its own address and to send its own correspondent information to others. For example, whenever the resident's network address changes, it would be typically beneficial to broadcast the new network address to all of its “known” correspondents (direct and indirect as stored in the resident computer system's data repository) so that those that are currently able to receive the updated address can store the updated information. A routine to broadcast this type of update is described below with reference to FIG. 18, and a routine that receives this broadcast and processes the update information is described below with reference to FIG. 19. Alternatively, whenever the resident's network address changes, it may instead be beneficial to broadcast the new network address to the direct correspondents of the resident computer system and to let it propagate the address further to those other systems in the community that are currently able to receive the address. A routine to handle a message to update a designated correspondent's address consistent with a propagation technique for network address updates is described below with reference to FIG. 13.

As another example, there are other times that it may be beneficial to send an update of a resident computer system's correspondent information (not just the resident computer system's network address). The steps to perform such an update are described with reference to FIG. 10, steps 1002-1004 and FIG. 11, steps 1102-1106. For instance, if a resident computer system cannot connect with another correspondent, it can record that fact, and, later, when the another correspondent comes on-line, the resident computer system can send an update with its own correspondent information or request a correspondent update from the another correspondent. Other potential beneficial times to perform such an update include when a resident computer system connects to the network (if it has been offline); when the resident computer system receives a new network address; or potentially each time the resident computer system receives a new address from one of its direct correspondents; or, perhaps, at these or any other time, the resident computer system can explicitly request a correspondent information update. One skilled in the art will recognize that many such combinations and other options exist and are contemplated for use with the present techniques.

FIG. 18 is an example flow diagram of a routine executed by an example peer-to-peer directory system portion for broadcasting an updated network address for the resident computer system to its correspondents. The updated network address is sent to each correspondent having an associated entry in the resident computer system's data repository. One skilled in the art will recognize that variations and subsets of the particular correspondents to which the updates are broadcast can be determined and appropriated modifications made to the process illustrated by FIG. 18. It is also understood that one or more of the correspondents to which a broadcasted message is sent may not receive the message, but that, odds are, some member computer system will receive the update and be available later to provide the updated address. Specifically, in step 1801, the routine sets a current entry to the next correspondent entry from the data repository starting with the first. In step 1802, the routine determines whether there are more entries to process, and, if so, continues in step 1803, otherwise returns. In step 1803, the routine determines whether the current entry indicates a correspondent that is the resident system (which may occur if the resident correspondent is an indirect correspondent of one of the resident computer system's correspondents), and, if so, skips the entry returning to the beginning of the loop in step 1801, otherwise continues in step 1804. In step 1804, the routine retrieves the name of the correspondent indicated by the current entry. In step 1805, the routine retrieves the relationship path of the correspondent indicated by the current entry and prepares a new relationship path that indicates the resident computer system as it would appear appropriately to the recipient computer system of the broadcast message. So, for example, in one embodiment, the relationship path is reversed (to list indications from the recipient system back up to the resident system) and an indicator to the resident system is appended, if not already present, to the end of the reversed path. In step 1806, the routine retrieves the last known address (as stored) of the correspondent indicated by the current entry. In step 1807, the routine sends a PPDS_Update_Address message, passing the temporarily revised relationship path and the updated address, to the correspondent indicated by the current entry at its retrieved address. The PPDS_Update_Address routine is described below with reference to FIG. 19, and is similar to FIGS. 13A and 13B except that propagation isn't necessary because the updated address is already being broadcast to direct and indirect correspondents of the resident computer system.

FIG. 19 is an example flow diagram of a routine executed by an example peer-to-peer directory system portion in response to receiving a network address update message to update a network address of a correspondent. The handler routine receives a designated name (relationship path) for the correspondent to be updated, an updated address, and an effective date/time. The steps of FIG. 19 are essentially the same as steps 1301-1306 of FIGS. 13A and 13B (update the data repository with the new network address of the designated correspondent). In step 1901, the handler looks for an entry in the correspondent information data repository of the receiving computer system. In step 1902, if there is a match (the relationship path retrieved is the same as the designated name), then the correspondent is a known correspondent and the handler continues in step 1904, else continues in step 1903. In step 1903, the handler needs to address a (typically error) situation where it receives an address for an unknown correspondent. Multiple options are possible and are described with reference to FIGS. 13A and 13B. In step 1904, the handler retrieves the stored network address information for the matching entry and in step 1905 determines whether the designated address is newer (by comparing the designated date and time with the retrieved date and time). If newer, the handler continues in step 1906 to update the entry with the designated address and date and time information, otherwise ignores the entry. The handler then returns.

As mentioned, as an alternative to broadcasting a resident computer system's updated network address to all of its correspondents, another technique may be used which broadcasts the updated network address to its direct correspondents and then lets them propagate the new address appropriate to the level of tracking of each system. FIGS. 13A and 13B are an example flow diagram of a routine to executed by an example peer-to-peer directory system portion in response to receiving a network address tracking message to update a network address of a correspondent. The handler routine receives a designated name (relationship path) for the correspondent to be updated, an updated address, and an effective date/time. In overview, the handler routine updates the network address of the designated correspondent and propagates the updated address to its direct correspondents according to the number of tracking levels. In step 1301, the handler looks for an entry in the correspondent information data repository of the receiving computer system. In step 1302, if there is a match (the relationship path retrieved is the same as the designated name), then the correspondent is a known correspondent and the handler continues in step 1304, else continues in step 1303. In step 1303, the handler needs to address a (typically error) situation where it receives an address for an unknown correspondent. Multiple options are possible. Either the handler can (1) ignore the requested update; (2) if the designated correspondent is a direct correspondent, the handle can query the user to determine whether to add the correspondent; or (3) if the designated correspondent is an indirect correspondent, the handler can send a message back to the sender of the message indicating an error and requesting a proper PPDS_Update_With_CInfo message if it is really one of the sender's correspondents. One skilled in the art will recognize that other options are possible. In step 1304, the handler retrieves the stored network address information for the matching entry and in step 1305 determines whether the designated address is newer (by comparing the designated date and time with the retrieved date and time). If newer, the handler continues in step 1306 to update the entry with the designated address and date and time information, otherwise continues in step 1307 to examine whether to propagate the received address information. In step 1307, the handler determines whether the level of the designated name (relationship path) is less than the tracking level, and, if so, continues in step 1308, otherwise returns. The level of the designated name is preferably less than the tracking level, so that messages are only sent to correspondents up through the number of tracking levels, since another indicator is added by the receiving system prior to propagation in step 1308. In step 1308, the handler prepares a new (temporary) relationship path as the designated name to be propagated, by prepending an indicator to itself. Steps 1309-1310 propagate the information. In step 1309, the handler retrieves a list of the direct correspondents, and filters out from the list the sending correspondent. In step 1310, the handler sends an PPDS_Update message to each of the directs on the filtered list with the designated updated relationship path that corresponds to the correspondent whose address is being updated, and then returns.

Note that it is possible in FIGS. 19, 13A, and 13B (and at other times) that a recipient doesn't receive a message because it may be off-line, unavailable, at a new address, etc. One skilled in the art will recognize that techniques similar to those employed when a peer-to-peer application cannot contact another application can be incorporated in conjunction with these routines as well. For example, the calling routine may invoke the PPDS itself to find a new address for the intended recipient, or it can periodically retry the message. One skilled in the art will recognize that other options may be incorporated as well.

A user or an application of a resident computer system can also designate that a particular correspondent computer system cease to be tracked by the PPDS, for example, via a user interface of a PPDS portion of an application. In such case, the PPDS of the resident computer system effectively removes network address knowledge of the designated computer system from its data repository and contacts its direct correspondents (sends a message) for them to do the same.

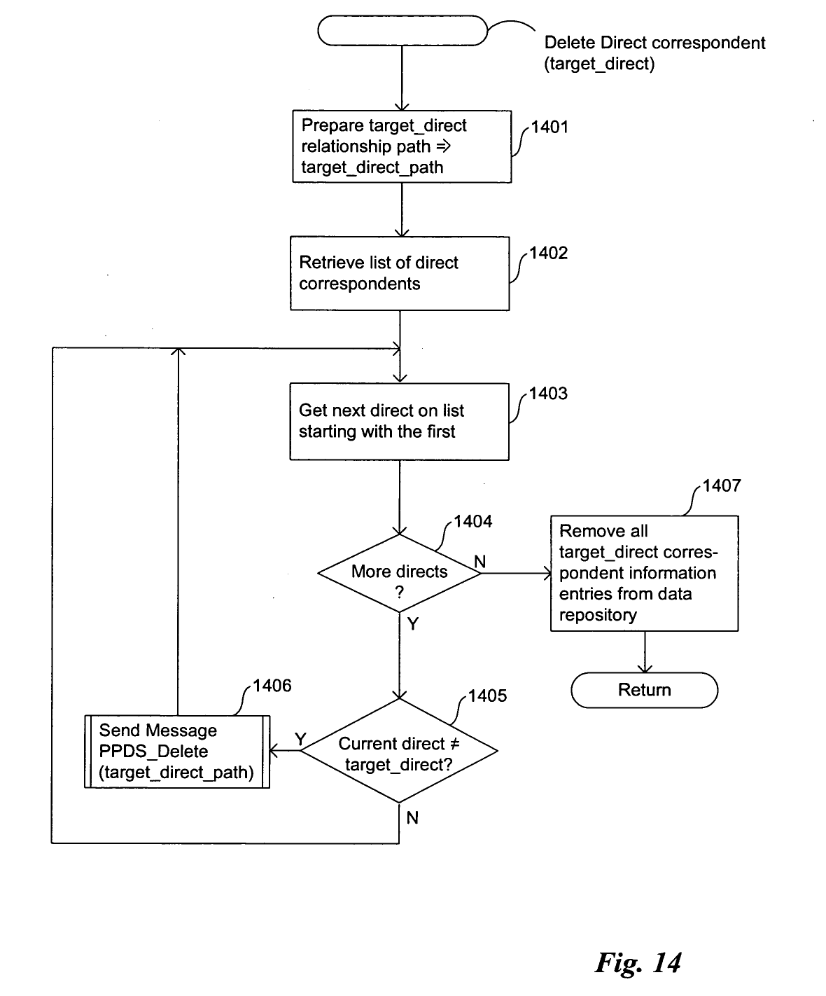

FIG. 14 is an example flow diagram of a routine executed by an example peer-to-peer directory system portion of a resident computer system for deleting a direct correspondent from the peer-to-peer directory system. An indication of a target computer system to cease to track is designated as an input parameter. In step 1401, the routine prepares a relationship path associated with the designated direct correspondent and prepends an indication of the resident computer system to the path to be used for propagating information. For example, if the routine of FIG. 14 is being executed by computer system A with computer system X being the designated correspondent to delete, then the relationship path that is to be propagated by computer system A is “A→X.” In step 1402, the routine retrieves a list of the direct correspondents from the data repository of the resident computer system. In step 1403, the routine gets the next direct correspondent from the list as the current direct and in step 1404 determines whether there are more to process. If so, the routine continues in step 1405, else continues in step 1407. In step 1405, the routine determines whether the current direct correspondent being processed is the same as the designated one, and, if so, returns to get the next direct correspondent (skips it), otherwise continues in step 1406 to send an PPDS_Delete message passing the relationship path of the target revised to include an indicator of the resident system to propagate the information to the current direct correspondent. Similar to the propagation described with reference to FIGS. 11 and 13, the propagation will stop when the threshold level of indirection is reached. When, in step 1404, there are no more direct correspondents to process in the retrieved list, then in step 1407 the routine removes the network address information that is associated with the designated correspondent from the data repository. For example, in the data repositories indicated in FIGS. 8A-8B, if computer system E were the direct correspondent designated to be removed, then all of the entries corresponding to E, E:C, E:C: . . . , E:K, and E:K: . . . Would be removed from the data repository.

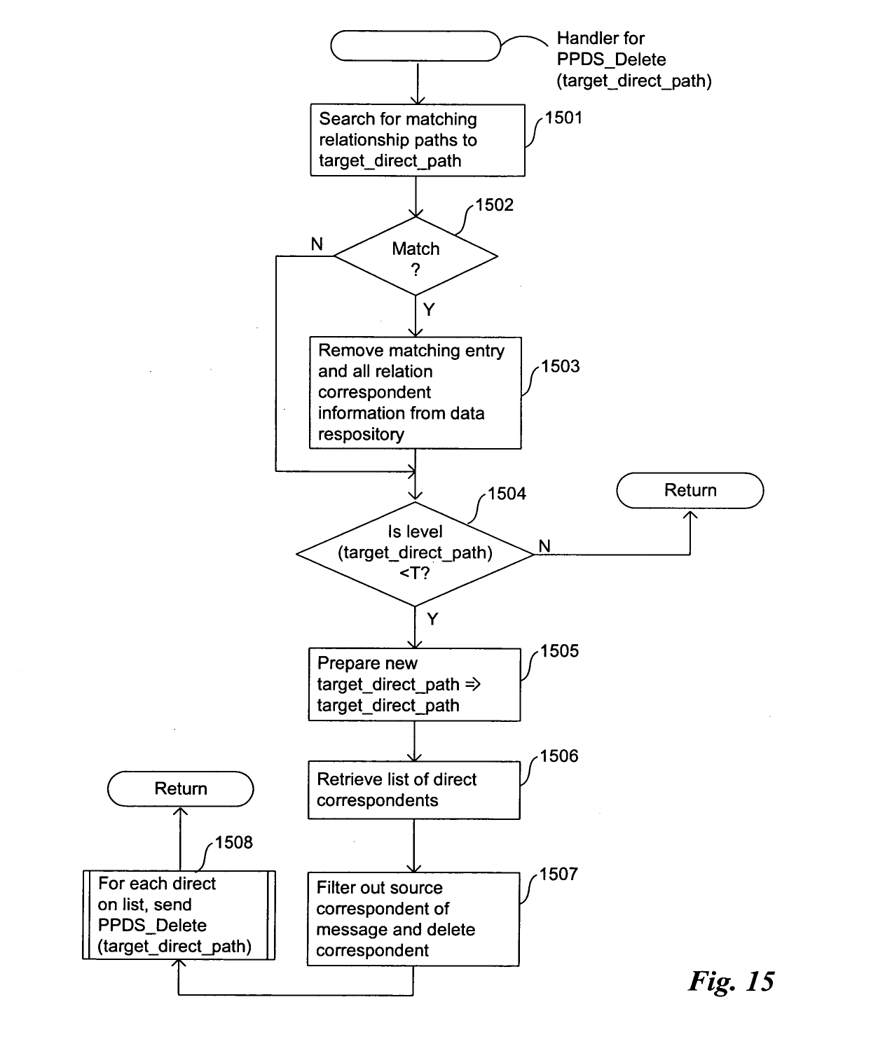

As mentioned, when a direct correspondent is designated as one for which tracking by the PPDS is to cease, a message to each computer system's direct correspondents is propagated. FIG. 15 is an example flow diagram of a routine executed by an example peer-to-peer directory system portion in response to receiving a network address tracking message to delete a correspondent. The handler routine receives a designated name (including a relationship path) for the correspondent to be deleted. In step 1501, the message handler searches the data repository of the resident computer system for matching relationship paths. In step 1502, the handler determines whether there are any matches, and, if so, continues in step 1503, else continues in step 1504. Matches will occur if the designated relationship path is present in the correspondent information for the correspondent to be deleted. (The designated path occurs at a beginning of any relationship path starting at the first indicator in the path.) So, for example, the designated path “A→X” matches “A→X,” “A→X→B,” etc. In step 1503, the handler removes the matching entries for the target_direct_path including whatever correspondent information is stored. In step 1504, the handler determines whether the designated relationship path is less than the tracking level and, if so, continues in step 1505 to propagate the deletion, else returns. (The number of indicated computer systems in the designated path is preferably less than the tracking level, because another indicator is added by the resident system prior to propagation. This ensures that messages are only sent to correspondents up through the number of tracking levels.) In step 1505, the handler prepares a new (temporary) relationship path by prepending an indication of the resident computer system to the path to be used to continue propagating the information. In step 1506, the hander retrieves a list of the direct correspondents, and in step 1507 filters out from the list the correspondent that sent the PPDS_Delete message. In step 1508, the handler sends an PPDS_Delete message to each of the directs on the filtered list with the designated relationship path that corresponds to the correspondent that is being eliminated from PPDS tracking.

In addition to explicitly requesting that a particular correspondent cease to be tracked by the community, it may be desirable to have each PPDS portion periodically delete entries in its data repository that have not been referenced over some period of time. Many forms of referencing entries may be tracked, including, for example, network address updates for a correspondent, queries for a correspondent's current address, queries originating from a correspondent for others, etc. One skilled in the art will recognize that there are many other aspects that can conceivably be tracked to determine whether an entry is sufficiently referenced over some designated period of time, and that time may be indicated in many ways, such as periods of time, discrete events, etc.

As described in FIGS. 1-6, one of the functions of a peer-to-peer directory system in a first computer system is to locate a target correspondent computer system through other member computer systems of the community, including correspondents that are not otherwise related to the first computer system, when the target correspondent computer system is unreachable. The PPDS automatically determines a location for the target correspondents by querying the other member computer systems of the community as necessary to find a current network address for the target correspondent computer system. In one embodiment, the location routine searches its own data repository correspondent information and contacts correspondents in a determined order until an address is located for the desired target computer system or until there are no more direct or indirect correspondents of the resident computer system to query. In another embodiment, the location routine is called recursively to find addresses of correspondents (working back up relationship paths once a computer system is found with a working address) until an address is located for the desired target computer system or until related correspondent paths have been exhausted.

There are many reasons why a user's computer system may be unreachable over a network, including that the user's computer system is no longer using the network address that was recorded for it. For example, a network message may have been returned indicating that the network address is not in use or that someone else (another computer system) has been assigned that address. Alternatively, the user's computer system may be off-line and therefore does not respond. When a computer system does not respond there is no way to tell if it has retained the same network address or if it has been assigned to another system. In addition, when a computer system does not respond, there is no way to tell whether the correspondent system is off-line or on-line with a new network address. Thus, when a correspondent computer system is unreachable, it makes sense for an application to seek an updated network address in any case, because the cause may not be knowable. Thus, when a correspondent is unreachable, the application uses the PPDS to try find an updated network address. Because of the possibility that a different user may be now using a correspondent's old network address, once an address is returned, the application (or underlying communications software) may want to employ authentication measures to ensure that the actual respondent is the correspondent expected.

FIGS. 20A and 20B are an example flow diagram of a routine to find a correspondent's new network address in an example community-based peer-to-peer directory service. These figures correspond to an embodiment which queries direct and indirect correspondents based upon current contents of the resident computer system's data repository. A desired correspondent is designated as an input parameter. In summary, the Find_New_Network_Address_Directly routine contacts correspondents in some determined order until one is found that returns a working address for the designated target, or until all correspondent entries have been exhausted. In the example illustrated, the order that correspondents are queried is by level (e.g., level 1 correspondents, then level 2, level 3, etc.); however, one skilled in the art will recognize that many other orderings can be integrated with the described techniques, including, but not limited to, ordering by the order the correspondents are stored in the data repository, by entries whose paths contain the target name, or by weightings or rankings as to prior history of valid responses as described further below.

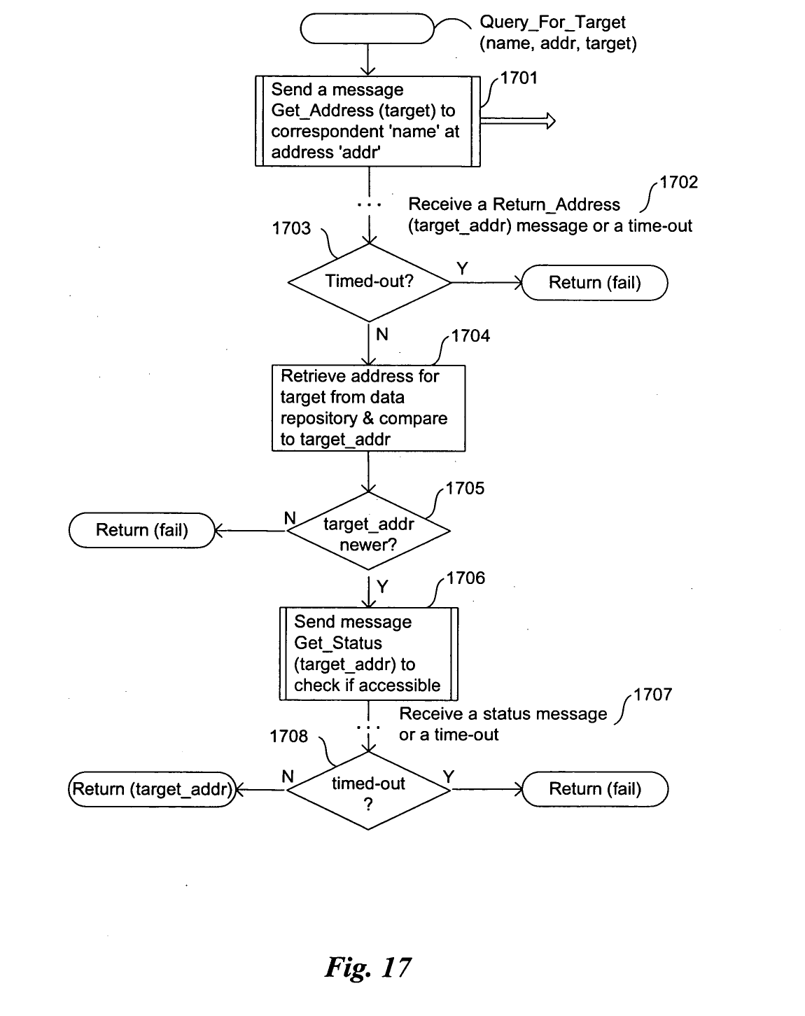

Specifically, in step 2001, the routine initializes the ordering variable (here the current level). In step 2002, the routine increments the ordering variable, for example, increments the current level. In step 2003, the routine determines whether the current level is within the threshold number of levels that are tracked in this repository, and, if so, continues in step 2004, otherwise returns a failed status. In step 2004, the routine retrieves the correspondent entries at the current level from the data repository, and sets the current query list to the retrieved entries. In some embodiments, various heuristics can be used to filter or reorder this list as necessary, including that, in step 2005, the routine filters out an entry that corresponds to the designated target system if one is present in the query list. In step 2006, the routine sets the current correspondent entry to the next entry in the current query list starting with the first entry. In step 2007, the routine determines whether it has reached the end of the current query list, and, if so, continues back to the beginning of the loop to prepare a query list at the next level at step 2002, otherwise continues in step 2008. In step 2008, the routine sets a current address to a retrieved last known address for the current correspondent. In step 2009, the routine retrieves a current path for the current correspondent and prepares a new path to be able to direct the correspondent to the correct target. Specifically, in one embodiment the retrieved path is reversed, an indicator to the resident system is appended to the reversed path, and then an indicator to the designated target system is appended to the path created thus far. This allows the path to appear to the current correspondent when the path is received as the path to the target would be stored in that correspondent's data repository. Since names of systems are not necessarily unique, passing the path allows the receiving correspondent to properly make sure it knows which target is being requested. In step 2010, the routine invokes a Query_For_Target routine to attempt to contact the current correspondent using the retrieved address for the current correspondent and designating the prepared path as the target. The Query_For_Target routine is described below with respect to FIG. 17. In step 2011, if the query was successful (an address to the proper target was returned), then this address is returned as the return value of the routine, otherwise the routine loops back to step 2006 to query the next correspondent on the query list.

FIGS. 16A and 16B are an example flow diagram of an alternate routine to find a correspondent's new network address in an example community-based Peer-to-Peer Directory Service. These figures correspond to an embodiment in which the correspondents are queried recursively. A desired correspondent is designated as an input parameter. In summary, the Find_New_Network_Address routine first contacts correspondents from a list of direct correspondents of the designated correspondent to try to obtain a target address. During the process, the routine keeps track of which correspondents did not answer. Once the direct correspondents have been exhausted and the target address not found, the routine uses the non-answering correspondents and recursively calls itself to try to get an address of a non-answering correspondent, and so on, until a correspondent is found that can be contacted and returns the desired correspondent addresses up each of the preceding levels until the target address is returned. One skilled in the art will recognize that the number of recursions can be limited in other ways as well, such as only recursing to one level of indirection to obtain a target address.

Specifically, in step 1601, a local target correspondent variable is set to the designated correspondent. In step 1602, a query list (list of correspondents to be potentially queried further) is set to the direct correspondents of the target correspondent by querying the data repository. In step 1603, the routine retrieves the next correspondent from the query list starting with the first as the current query correspondent. In step 1604, the routine determines whether there are more potential correspondents to query, and, if so, continues in step 1605, else continues in step 1610. In step 1605, the routine retrieves from the data repository the last known address associated with the current query correspondent. In step 1606, the routine calls another routine to attempt to contact the current query correspondent using the retrieved address. This Query_For_Target routine is described below with respect to FIG. 17. In step 1607, if the contact was successful (the target address was returned), then this address is returned as the return value of this invocation of the recursion. Otherwise, then in step 1609, the current query correspondent is saved on a list of non-answering correspondents to be recursively searched. The routine then returns to the beginning of the loop of searching the query list in step 1603.

In step 1610, when the current query list has been exhausted for this invocation of the routine, the routine determines whether there are any non-answering correspondents to continue to query, and if so continues in step 1611, else returns a failure status (the target address of the current correspondent cannot be found at this time). Then, in steps 1611-1617, the routine executes a loop to recursively search the list of non-answering correspondents for a direct correspondent that knows a working address of a non-answering correspondent. Specifically, in step 1611, the routine determines whether the level of the non-answering correspondent is less than the number of tracking levels stored in the data repository (otherwise it won't have its own direct correspondents to query for its address), and, if so, continues in step 1612, else returns a failure status. One skilled in the art will recognize that this test of whether to go another level deep in the recursion could be performed at other times. In step 1612, the routine retrieves the next correspondent from the list of non-answering correspondents starting with the first as the current query correspondent. In step 1613, the routine determines whether there are more potential non-answering correspondents to query, and, if so, continues in step 1614, else returns a failure status. In step 1614, the routine recursively invokes itself to search for a target address of the current query correspondent. In step 1615, the return status is examined, and if an address is returned, then the routine continues in step 1616, else it continues to loop to the next correspondent on the list of non-answering correspondents in step 1612. In step 1616, the routine invokes another routine to attempt to contact the current query correspondent using the returned address for the current query correspondent. This Query_For_Target routine is described below with respect to FIG. 17. In step 1617, if the contact was successful (an address was returned), then this address is returned as the return value of this invocation of the recursion, otherwise the routine continues to loop to the next correspondent on the list of non-answering correspondents in step 1612.

FIG. 17 is an example flow diagram of a routine to attempt to contact a correspondent using a potential network address to retrieve a current address for a target correspondent in an example community-based peer-to-peer directory service. The routine receives as input a designated correspondent name, an associated network address to use for the contact, and a desired (target) correspondent name. Note that, in the case where this routine is called in an embodiment that queries indirect correspondents “directly,” a path to the desired (target) correspondent is designated (not just the target name), so that the receiving correspondent can properly identify the desired target system. This routine can be supplemented to try any number of additional ways to contact the computer system named by the designated correspondent name at the designated associated address if directly querying the designated correspondent fails, dependent upon desired responsiveness. In step 1701, the routine sends a Get_Address message to the correspondent named by the designated correspondent name using the designated network address and to query it for an address for the target correspondent named by the designated target correspondent name. Although not shown, one skilled in the art will recognize that the Get_Address message handler essentially retrieves and returns an associated address in a Return_Address message if one exists for the requested target correspondent name in its data repository. In step 1702, either a response to the Get_Address message (a Return_Address message) is received or a period of time to respond is exceeded (a timeout occurs). In step 1703, the routine determines whether a timeout occurred, and, if so, returns a failure status, otherwise continues in step 1704. In step 1704, the routine retrieves an address for the designated target from the resident computer system's data repository (to compare it). In step 1705, the routine compares the target address received in the Return_Address message with the retrieved address, and, if more recent, continues in step 1706, otherwise returns a failure status. In step 1706, the routine tries the more recent address for the designated correspondent by sending a Get_Status message (e.g., a ping or some other message to tell if the target is alive/on-line) to the target correspondent at the recently received address. In step 1707, either a Status message is returned from the target correspondent or a timeout occurs. In step 1708, if a timeout occurred, then the routine returns a failure status, otherwise the routine returns address that was received in the Return_Address message. Optionally, the routine performs authentication to make sure that the address received in the Return_Address message is for the computer system named by the designated target correspondent name. One skilled in the art will recognize that additional messages may also be sent and received in the process.

If the Find_New_Network_Address routine is not successful at locating an updated network address for the target correspondent, then the peer-to-peer application or other software that invoked the routine is notified and the application can choose a different course of action dependent upon its goals. For example, the application can retry the PPDS operation at a later time. This tactic eventually will be successful if the target correspondent was simply off-line. Or, for example, the PPDS may offer an alternative mechanism to the community-based approach that sends email to request an updated network address (as described with reference to FIG. 9; see also step 207 of FIG. 2). Or, a combination of these approaches may be employed. Also, a default backup strategy to utilize one of these approaches may be specified at installation time, or when the PPDS operation was requested, or at some other time.

Several enhancements can be made to the automated location service provided by a PPDS. One skilled in the art will recognize how such enhancements can be integrated in the routines described with reference to FIGS. 20A, 20B, 16 and 17. First, the service can incorporate a scheme for ranking or weighting the correspondents as to their effectiveness in returning current network address. This way, the search can be optimized to query those correspondents first as they are more likely to return the sought after address. This technique is particularly useful when some of the member computer systems in the community have addresses that are less dynamic than others (or static). In addition, the rankings or weightings may be recalculated (in whole or in part) after each query and more recent queries given more weight.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/484,803, entitled “PEER-TO-PEER DIRECTORY SYSTEM,” filed Jul. 3, 2003; and U.S. patent application Ser. No. 10/838,293, entitled METHOD AND SYSTEM FOR RECIPROCAL DATA BACKUP, filed May 4, 2004, are incorporated herein by reference, in their entirety.

From the foregoing it will be appreciated that, although specific embodiments of the invention have been described herein for purposes of illustration, various modifications may be made without deviating from the spirit and scope of the invention. For example, one skilled in the art will recognize that the methods and systems for performing directory services discussed herein are applicable to other architectures other than purely peer-to-peer architecture. For example, the PPDS facilities may be offered in conjunction in a community with a computer system that has a static IP address. Also, portions of the PPDS may be offered for fee. For example, member systems with static IP addresses may charge for locating addresses of correspondents. One skilled in the art will also recognize that the methods and systems discussed herein are also applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A method in a computer system for determining a current network address of a target direct correspondent computer system in a community of correspondent computer systems, the community comprising at least the target direct correspondent computer system and at least one indirect correspondent computer system that is a correspondent of the target direct correspondent computer system, comprising:
receiving and storing network address information associated with a plurality of computer systems in the community of correspondent computer systems, at least one of the computer systems in the community having a dynamically changing network address;
retrieving a stored most recent network address information associated with the at least one indirect correspondent computer system; and
communicating with the at least one indirect correspondent computer system using the retrieved most recent network address information to automatically determine the current network address for the target direct correspondent computer system.

2. The method of claim 1, further comprising receiving a request for a current network address of the target direct correspondent computer system;

3. The method of claim 1 performed without using an intermediate directory server with a static network address.

4. The method claim 1 performed in conjunction with using an intermediate directory server with a static network address.

5. The method of claim 1 wherein the communicating with the at least one indirect correspondent computer system to automatically determine the current network address for the target direct correspondent computer system is performed when it is determined that the target direct correspondent computer system is not accessible using a most recent stored network address for the target direct correspondent computer system.

6. The method of claim 1, further comprising:
successfully establishing contact with the target direct correspondent computer system using the automatically determined current network address.

7. The method of claim 1 wherein the indirect correspondent computer system is greater than two levels of correspondents away from the computer system.

8. The method of claim 1, the community of correspondent computer systems having a plurality of correspondent computer systems associated with the target direct correspondent computer system, the at least one indirect correspondent computer system being one of the plurality of correspondent computer systems, wherein the communicating with the at least one indirect correspondent computer system using the retrieved network address information to automatically determine the current network address for the target direct correspondent computer system comprises:
successively attempting to communicate with the plurality of correspondent computer systems associated with the target direct computer system using stored network address information associated with each correspondent computer system until a current network address of the at least one indirect computer system is determined; and
communicating with the at least one indirect correspondent computer system using the determined current network address of the at least one indirect computer system to automatically determine the current network address for the target direct correspondent computer system.

9. The method of claim 8 wherein the successively attempting to communicate with the plurality of correspondent computer systems associated with the target direct computer system recursively attempts to communicate with the plurality of correspondent computer systems associated with the target direct computer system until a current network address of the at least one indirect computer system is determined.

10. The method of claim 8 wherein the plurality of correspondent computer systems comprises at least one direct correspondent of the target direct correspondent computer system and at least one indirect correspondent of the target direct correspondent.

11. The method of claim 8 wherein the successively attempting to communicate with the plurality of correspondent computer systems attempts to communicate with at least two levels of indirect correspondent computer systems before the current network address of the at least one indirect computer system is determined.

12. The method of claim 8 wherein the at least one indirect correspondent computer system is a direct correspondent of the target direct correspondent computer system.

13. The method of claim 8 wherein the at least one indirect correspondent computer system is an indirect correspondent of the target direct correspondent computer system.

14. The method of claim 1 wherein the network address information stored with each computer system is a network address.

15. The method of claim 1 wherein the network address information comprises additional information to the network address.

16. The method of claim 15 wherein the additional information comprises correspondent information.

17. The method of claim 15 wherein the additional information comprises an effective time period associated with the network address.

18. The method of claim 1 wherein the stored network address information includes Internet Protocol (“IP”) network addresses.

19. The method of claim 1 wherein the stored network address information includes heterogeneous types of network addresses.

20. The method of claim 19 wherein one of the heterogeneous types of stored the network addresses includes a private LAN address.

21. The method of claim 1 wherein the all of the network addresses stored as network address information are a homogeneous type of network address.

22. The method of claim 1 wherein the receiving and storing network address information associated with the plurality of the computer systems in the community of correspondent computer systems comprises:
receiving an indication of a network address for a direct correspondent computer system; and
receiving an indication of a network address of and a relationship path to a correspondent of the direct correspondent computer system.

23. The method of claim 22 wherein the receiving the indication of the network address for the direct correspondent and receiving the indication of the network address of and the relationship path to the correspondent of the direct correspond occur at different times.

24. The method of claim 22 wherein each indicated relationship path indicates an association between a plurality of correspondent computer systems.

25. The method of claim 22 wherein the receiving the indication of the network address for the direct correspondent computer system and the indication of the network address of and the relationship path to the correspondent of the direct correspondent computer system is performed for each of a plurality of direct correspondent computer systems of the computer system.

26. The method of claim 22 wherein the direct correspondent computer system has a direct relationship path to a third correspondent computer system and has an indirect relationship path to a fourth correspondent computer system through the third correspondent computer system, the fourth correspondent computer system being an indirect correspondent of the direct correspondent computer and being a direct correspondent of the third correspondent computer system.

27. The method of claim 22 wherein the receiving is performed on a periodic basis.

28. The method of claim 22 wherein the receiving the indication of the network address for the direct correspondent computer system is performed when the network address of the direct correspondent computer system has been updated.

29. The method of claim 22, further comprising:
forwarding the received indications to direct correspondent computer systems of the computer system.

30. The method of claim 1, further comprising:
determining that the computer system has an updated network address; and
forwarding the updated network address to direct correspondent computer systems of the computer system.

31. The method of claim 1, further comprising:
receiving an indication that a correspondent computer system is to be no longer accessible; and
removing access to the stored network address information associated with the indicated correspondent computer system.

32. The method of claim 31 wherein the stored network address information that is removed comprises network address information associated with indirect correspondents of the indicated correspondent computer system.

33. The method of claim 31, further comprising:
forwarding the indication that the correspondent computer system is to be no longer accessible to a direct correspondent computer system of the computer system.

34. The method of claim 1, the receiving and storing network address information associated with each computer system in the community comprising:
initially receiving network address information for a direct correspondent computer system from at least one of an indication from a user, a notification from an application, data associated with an application, stored network information associated with a different correspondent computer system, or a network address received in response to an email inquiry to the direct correspondent computer system.

35. A computer-readable memory medium containing instructions that control a computer processor to determine a current network address of a target direct correspondent computer system in a community of correspondent computer systems, the community comprising at least the target direct correspondent computer system and at least one indirect correspondent computer system associated with the target direct correspondent computer system by:
receiving and storing network address information associated with a plurality of computer systems in the community of correspondent computer systems, at least one of the computer systems in the community having a dynamic network address;
retrieving a stored most recent network address information associated with the at least one indirect correspondent computer system; and
communicating with the at least one indirect correspondent computer system using the retrieved most recent network address information to automatically determine the current network address for the target direct correspondent computer system.

36. The memory medium of claim 35, wherein the instructions further comprise receiving a request for a current network address of the target direct correspondent computer system.

37. The memory medium of claim 35 wherein the instructions are executed without using an intermediate directory server with a static network address.

38. The memory medium of claim 35 wherein the instructions are executed in conjunction with using an intermediate directory server with a static network address.

39. The memory medium of claim 35 wherein the communicating with the at least one indirect correspondent computer system to automatically determine the current network address for the target direct correspondent computer system is performed when it is determined that the target direct correspondent computer system is not accessible using the most recent stored network address for the target direct correspondent computer system.

40. The memory medium of claim 35, further comprising:
successfully establishing contact with the target direct correspondent computer system using the automatically determined current network address.

41. The memory medium of claim 35 wherein the indirect correspondent computer system is greater than two levels of correspondents from the computer system.

42. The memory medium of claim 35, the community of correspondent computer systems having a plurality of correspondent computer systems associated with the target direct correspondent computer system, further containing instructions to control the computer processor by:
successively attempting to communicate with the plurality of correspondent computer systems associated with the target direct correspondent computer system using stored network address information associated with each correspondent computer system until a current network address of the at least one indirect computer system is determined; and
communicating with the at least one indirect correspondent computer system using the determined current network address of the at least one indirect computer system to automatically determine the current network address for the target direct correspondent computer system.

43. The memory medium of claim 42 wherein the successively attempting to communicate with the plurality of correspondent computer systems associated with the target direct computer system recursively attempts to communicate with the plurality of correspondent computer systems associated with the target direct computer system until a current network address of the at least one indirect computer system is determined.

44. The memory medium of claim 42 wherein the at least one indirect correspondent computer system is a direct correspondent of the target direct correspondent computer system.

45. The memory medium of claim 42 wherein the at least one indirect correspondent computer system is an indirect correspondent of the target direct correspondent computer system.

46. The memory medium of claim 35 wherein the network address information stored with each computer system is a network address.

47. The memory medium of claim 35 wherein the network address information comprises correspondent information.

48. The memory medium of claim 35 wherein the stored network address information includes Internet Protocol (“IP”) network addresses.

49. The memory medium of claim 35 wherein the stored network address information includes a private LAN address.

50. The memory medium of claim 35 wherein the receiving and storing network address information associated with each computer system in the community of correspondent computer systems comprises:
receiving an indication of a network address for a direct correspondent computer system; and
receiving an indication of a network address of and a relationship path to a correspondent of the direct correspondent computer system.

51. The memory medium of claim 50 wherein the receiving the indication of the network address for the direct correspondent and receiving the indication of the network address of and the relationship path to the correspondent of the direct correspond occur at different times.

52. The memory medium of claim 50 wherein each indicated relationship path indicates an association between a plurality of correspondent computer systems.

53. The memory medium of claim 50 wherein the receiving is performed on a periodic basis.

54. The memory medium of claim 50 wherein the receiving the indication of the network address for the direct correspondent computer system is performed when the network address of a direct correspondent computer system has been updated.

55. The memory medium of claim 50 wherein the receiving the indication of the network address of and the relationship path to a correspondent of the direct correspondent computer system is performed when the network address of the correspondent of the direct correspondent computer system has been updated.

56. The memory medium of claim 50, further containing instructions to control the computer processor by:
transmitting the received indications to direct correspondent computer systems of the computer system.

57. The memory medium of claim 35, further containing instructions to control the computer processor by:
determining that the computer system has an updated network address; and
transmitting the updated network address to direct correspondent computer systems of the computer system.

58. The memory medium of claim 35, further containing instructions to control the computer processor by:
receiving an indication that a correspondent computer system is to be no longer accessible; and
removing access to the stored network address information associated with the indicated correspondent computer system.

59. The memory medium of claim 58, further comprising:
transmitting the indication that the correspondent computer system is to be no longer accessible to a direct correspondent computer system of the computer system.

60. The memory medium of claim 35, further containing instructions to control the computer processor by:
initially receiving network address information for a direct correspondent computer system from at least one of an indication from a user, a notification from an application, data associated with an application, stored network information associated with a different correspondent computer system, or a network address received in a message.

61. A computer system connected to a plurality of correspondent computer systems that communicate over a network, at least one of the correspondent computer systems having a dynamic network address, comprising:
a tracking agent that is structured to
receive and store a network address for the direct correspondent;
receive and store network address information associated with correspondents of the direct correspondent; and
forward the received network address for the direct correspondent to other direct correspondents of the computer system; and
a locating service component that is structured to
receive a request for an operational network address of the direct correspondent of the computer system;
retrieve a stored most recent network address for the direct correspondent along with network address information associated with at least one other correspondent of the computer system; and
when it is determined that the retrieved most recent network address for the direct correspondent is no longer operational, successively query for a current network address of the direct correspondent by contacting the correspondents of the computer system using the retrieved network address information until the operational network address is determined.

62. The system of claim 61 wherein the tracking agent is structured to forward the received network address information associated with correspondents of the direct correspondent to other direct correspondents of the computer system.

63. The system of claim 61 wherein the locating service component is structured to successively query direct and indirect correspondents of the direct correspondent, recursively searching for correspondents of the direct correspondent to respond until a current address for the direct correspondent is found.

64. The system of claim 61 wherein the network addresses include at least one of an IP address or a private LAN address.

65. The system of claim 61 wherein network address for the direct correspondent is received when the network address of the direct correspondent is modified.

66. The system of claim 61 wherein the tracking agent is further structured to determine when the network address of the computer system changes, and to forward the changed network address of the computer system to the direct correspondent of the computer system.

67. The system of claim 61 wherein the tracking agent is further structured to receive an indication that one of the correspondent computer systems is no longer accessible, and to remove network address information associated with the indicated correspondent computer system.

68. The system of claim 61 wherein the initial address for the direct correspondent of the computer system is received from at least one of an indication from a user, a notification from an application, data associated with an application, stored network information associated with a different correspondent computer system, or a network address received in a message.

69. A peer-to-peer directory service in a network of computer systems, each computer system having a dynamic network address, comprising:
a first one of the computer systems having a network address;
a second one of the computer systems having a dynamic network address and that is structured to receive and store a network address of the first computer system and network address information for direct and indirect correspondent computer systems of the first computer system;
a third one of the computer systems having a network address and that is structured to,
receive and store the network address of the second computer system and network address information for direct and indirect correspondent computer systems of the second computer system, wherein the direct correspondent computer systems of the second computer system include at least the first computer system; and
use the stored network address information of the third computer system to automatically determine an operational network address of the second computer system by querying at least one of the direct and indirect correspondent computer systems of the second computer system for a current network address of the second computer system.

70. The directory service of claim 69, wherein the third computer system is structured to determine the operational network address of the second computer system without using an intermediary directory service having a static network address.

71. The directory service of claim 69 wherein the indirect correspondent computer systems of the second computer system include at least the direct correspondent computer systems of the first computer system and wherein the third computer system retrieves and uses network address information for the indirect correspondent computer systems of the second computer system to locate the current network address of the second computer system.

72. The directory service of claim 69 wherein at least one of the dynamic network addresses is an IP address.

73. The directory service of claim 69 wherein at least one of the dynamic network addresses is a private LAN address.

74. The directory service of claim 69 wherein the updates to the network address received at a computer system are forwarded to the other computer systems in the network.

75. The directory service of claim 69 wherein a computer system receives an indication of an initial network address for an associated direct correspondent computer system from at least one of an indication from a user, a notification from an application, data associated with an application, stored network information associated with a different correspondent computer system, or a network address received in response to an email inquiry to the desired direct correspondent computer system.

76. A method for automatically tracking network addresses in a community of member computer systems that communicate with each other using peer-to-peer technology, comprising:
in each member computer system,
receiving network address information from a first level correspondent computer system of the member computer system including at least an indication of a network address of the first level correspondent and an indication of a network address and a relationship path to at least one correspondent of the first level correspondent;
storing the network address information received from the first level correspondent computer system; and
when an update occurs to a network address of the member computer system, using the received network address information from the first level correspondent computer system to forward the updated network address of the member computer system to the first level correspondent computer system and to correspondent computer systems of the first correspondent computer system so that the network address information is mutually shared among member computer systems of the community.

77. The method of claim 76, further comprising:
using the stored indication of the network address and the relationship path for the at least one correspondent of the first level correspondent to search for a current network address for communicating with the first level correspondent computer system.

78. The method of claim 76, the forwarding the updated network address of the member computer system comprising:
forwarding the updated network address of the member computer system to each correspondent of the first level correspondent until a determined threshold level of indirection is reached.

79. The method of claim 76, the storing the network address information received from the first level correspondent comprising:
storing the network address information for each correspondent of the first level correspondent until a determined threshold level of indirection is reached.

80. The method of claim 76, further comprising:
in each member computer system,
forwarding at least a portion of the network address information received from the first level correspondent computer system of the member computer system to other correspondent computer systems of the member computer system.

81. The method of claim 80, the forwarding the at least the portion of the network address information received from the first level correspondent computer system comprising:
forwarding at least the portion of the network address information received from the first level correspondent computer system consistent with a determined number of levels of correspondent computer systems.

82. The method of claim 76, further comprising:
receiving network address information for an indirect correspondent computer system of the member computer system that is related to the member computer system through at least a first level correspondent computer system of the member computer system, the network address information received for the indirect correspondent computer system including an indication of a network address of the indirect correspondent computer system and an indication of a network address and a relationship path to each direct correspondent and to each indirect correspondent of the indirect correspondent computer system.

83. The method of claim 82, further comprising:
forwarding the network address information received for the indirect correspondent computer system and for each direct correspondent and for each indirect correspondent of the indirect correspondent computer system consistent with a determined threshold level of indirection.

84. The method of claim 76, further comprising:
in each member computer system,
when indication of a new first level correspondent computer system is received, forwarding network address information, including at least an indication of a network address of the new first level correspondent, to the other first level correspondent computer systems of the member computer system.

85. The method of claim 84, further comprising:
in each member computer system,
when indication of a new first level correspondent is received, forwarding network address information for the member computer system to the new first level correspondent computer system.

86. The method of claim 76, further comprising:
in each member computer system,
when an update occurs to the network address of the member computer system, forwarding the updated network address of the member computer system to the direct and indirect correspondent computer systems of the member computer system.

87. The method of claim 76, further comprising:
forwarding with the updated network address of the member computer system, an effective time associated with the updated network address of the member computer system.

88. A computer-readable memory medium containing instructions that control a computer processor to automatically track network addresses in a community of member computer systems that communicate with each other using peer-to-peer technology, the computer processor residing in one of the member computer systems, by:
receiving network address information from a first level correspondent computer system of the one of the member computer systems including at least an indication of a network address of the first level correspondent and an indication of a network address and a relationship path to at least one correspondent of the first level correspondent;
storing the network address information received from the first level correspondent computer system; and
when an update occurs to a network address of the one of the member computer systems using the received network address information from the first level correspondent computer system to forward the updated network address of the one of the member computer systems to the first level correspondent computer system and to correspondent computer systems of the first correspondent computer system so that the network address information is mutually shared among member computer systems of the community.

89. The memory medium of claim 88, further comprising instructions that control the computer processor by:
using the stored indication of the network address and the relationship path for the at least one correspondent of the first level correspondent to search for a current network address for communicating with the first level correspondent computer system.

90. The memory medium of claim 88, the forwarding the updated network address of the one of the member computer systems, comprising:
forwarding the updated network address of the one of the member computer systems to each correspondent of the first level correspondent until a determined threshold level of indirection is reached.

91. The memory medium of claim 88, the storing the network address information received from the first level correspondent comprising:
storing the network address information for each correspondent of the first level correspondent until a determined threshold level of indirection is reached.

92. The memory medium of claim 88, further comprising instructions that control the computer processor by:
forwarding at least a portion of the network address information received from the first level correspondent computer system of the one of the member computer systems to other correspondent computer systems of the one of the member computer systems.

93. The memory medium of claim 92, wherein the forwarding is performed consistent with a determined number of levels of correspondent computer systems.

94. The memory medium of claim 88, further comprising instructions that control the computer processor by:
receiving network address information for an indirect correspondent computer system of the one of the member computer systems that is related to the one of the member computer systems through at least a first level correspondent computer system of the one of the member computer systems, the network address information received for the indirect correspondent computer system including an indication of a network address of the indirect correspondent computer system and an indication of a network address and a relationship path to each direct correspondent and to each indirect correspondent of the indirect correspondent computer system.

95. The memory medium of claim 88, further comprising instructions that control the computer processor by:
when indication of a new first level correspondent computer system is received, forwarding network address information, including at least an indication of a network address of the new correspondent, to first level correspondent computer systems of the one of the member computer systems.

96. The memory medium of claim 95, further comprising instructions that control the computer processor by:
when indication of a new first level correspondent is received, forwarding network address information for the one of the member computer systems to the new first level correspondent computer system.

97. The method of claim 88, further comprising instructions that control the computer processor by:
when an update occurs to the network address of the one of the member computer systems, forwarding the updated network address to the direct and indirect correspondent computer systems of the one of the member computer systems.

98. The method of claim 88, further comprising instructions that control the computer processor by:
forwarding with the updated network address of the one of the member computer system, an effective time associated with the updated network address.

99. A network address tracking system in each of a community of member computer systems that communicate with each other using peer-to-peer technology, comprising:
means for receiving network address information from a first level correspondent computer system of the member computer system including at least an indication of a network address of the first level correspondent and an indication of a network address and a relationship path to at least one correspondent of the first level correspondent;
means for storing the network address information received from the first level correspondent computer system; and
means for using the received network address information from the first level correspondent computer system to forward an updated network address of the member computer system to the first level correspondent computer system and to correspondent computer system of the first correspondent computer system so that the network address information is mutually shared among member computer systems of the community.

100. The system of claim 99, further comprising:
means for using the stored indication of the network address and the relationship path for the at least one correspondent of the first level correspondent to search for a current network address for communicating with the first level correspondent computer system.

101. The system of claim 99, the means for using comprising:
means for forwarding the updated network address of the member computer system to each correspondent of the first level correspondent until a determined threshold level of indirection is reached.

102. The system of claim 99, further comprising:
means for forwarding at least a portion of the network address information received from the first level correspondent computer system of the member computer system to other correspondent computer systems of the member computer system.

103. The system of claim 99, further comprising:
means for forwarding a portion of the network address information when indication of a new first level correspondent computer system is received, including at least an indication of a network address of the new correspondent, to the other first level correspondent computer systems of the member computer system.

104. The system of claim 99, further comprising:
means for forwarding a network address of the member computer system to the new first level correspondent computer system.

105. A software interface expressed as instructions stored in a computer-readable memory medium of a first correspondent computer system for providing a peer-to-peer directory service in a network of correspondent computer systems, comprising:
a tracking portion that, when executed by a computer processor,
receives network address information for at least a second correspondent computer system in the network and network address information for at least one correspondent computer system in the network that communicates with the second correspondent computer system;
stores the received network address information for the at least the second correspondent computer system and the network address information for the at least one other correspondent computer system; and
transmits to at least a third correspondent computer system the received network address information for the at least second correspondent computer system; and
a directory service portion that, when executed by a computer processor,
uses the stored network address information to automatically determine a current network address of the second correspondent computer system.

106. The software interface of claim 105 wherein the directory service portion is executed by the computer processor in response to a request from a peer-to-peer application for a network address of the second correspondent computer system.

107. The software interface of claim 105 wherein the tracking portion further is expressed as instructions that, when executed by the computer processor, transmit to the at least the third correspondent computer system the network address information for the at least one other correspondent computer systems.

108. The software interface of claim 105 wherein the directory service portion, when executed by the computer processor, uses the stored network address information for the at least one other correspondent computer system to automatically determine the current network address of the second correspondent computer system.

109. The method of claim 30, further comprising:
forwarding the updated network address to indirect correspondent computer systems of the computer system.

110. The memory medium of claim 57, further comprising instructions to control the computer processor by:
forwarding the updated network address to indirect correspondent computer systems of the computer system.

111. The system of claim 61 wherein the locating service component is further structured to successively query for a current network address of the direct correspondent by contacting the direct and indirect correspondents of the computer system in a determined order, using the retrieved network address information associated with the at least one correspondent of the computer system until the operational network address is determined.

112. The system of claim 111 wherein the determined order is at least one of correspondent level, a ranking, or a weighting of probable success.

113. The system of claim 63 wherein the locating service component is further structured to recursively query the direct and indirect correspondents of the direct correspondent in a determined order.

114. The system of claim 113 wherein the determined order is at least one of correspondent level, a ranking, or a weighting of probable success.

115. The method of claim 76, further comprising receiving and storing an indication of a network address and a relationship path to an indirect correspondent of the first level correspondent.

116. The method of claim 115, further comprising using the stored indication of the network address and the relationship path to the indirect correspondent of the first level correspondent to search for a current network address for communicating with the first level correspondent computer system.

117. A method in a computer system for determining a current network address of a target correspondent computer system in a community of correspondent computer systems, comprising:
mutually tracking, communicating, storing, and updating network address information associated with each of the correspondent computer systems in the community, at least one of the computer systems in the community having a dynamically changing network address that is propagated between the correspondent computer systems in the community; and
upon receiving a request for the current network address of the target correspondent computer system,
retrieving from the stored network address information a most recent address of the target correspondent computer system and determining whether the retrieved most recent address is current; and
when it is determined that the retrieved most recent address of the target correspondent computer system is not current, using the stored network address information associated with the rest of the correspondent computer systems in the community to directly communicate with one or more of the rest of the correspondent computer systems to automatically determine the current network address of the target correspondent computer system.

118. The method of claim 117 wherein communication with one or more of the rest of the correspondent computer systems is performed according to a determined order until the current network address of the target correspondent computer system is found or until all of the rest of the correspondent computer systems have been queried.

119. The method of claim 117 wherein the determined order is at least one of correspondent level, a ranking, or a weighting of probable success.

120. The method of claim 117, the network address information including a network address for each direct correspondent of the computer system and a network address and a relationship path for each correspondent of each direct correspondent of the computer system.

121. The method of claim 117 performed without using an intermediate directory server with a static network address.

122. The method of claim 117 performed in conjunction with using an intermediate directory server with a static network address.

123. The method of claim 117 wherein the mutually tracked correspondent computer systems include at least one indirect correspondent of the computer system, and wherein the network address of the at least one indirect correspondent of the computer system is used to automatically determine the current network address of the target computer system.

124. The method of claim 123 wherein the at least one indirect correspondent of the computer system is greater than two levels of correspondents away from the computer system.

125. The method of claim 117 wherein the stored network address information includes Internet Protocol (“IP”) network addresses.

126. The method of claim 117 wherein the stored network address information includes a private local area network (“LAN”) address.

127. A computer-readable memory medium containing instructions that control a computer processor to determine a current network address of a target correspondent computer system in a community of correspondent computer systems, by:
mutually tracking, communicating, storing, and updating network address information associated with each of the correspondent computer systems in the community, at least one of the computer systems in the community having a dynamically changing network address that is propagated between the correspondent computer systems in the community; and
upon receiving a request for the current network address of the target correspondent computer system,
retrieving from the stored network address information a most recent address of the target correspondent computer system and determining whether the retrieved most recent address is current; and
when it is determined that the retrieved most recent address of the target correspondent computer system is not current, using the stored network address information associated with the rest of the correspondent computer systems in the community to directly communicate with one or more of the rest of the correspondent computer systems to automatically determine the current network address of the target correspondent computer system.

128. The memory medium of claim 127 wherein communication with each of the rest of the correspondent computer systems is performed according to a determined order until the current network address of the target correspondent computer system is found or until all of the rest of the correspondent computer systems have been queried.

129. The memory medium of claim 127 wherein the determined order is at least one of correspondent level, a ranking, or a weighting of probable success.

130. The memory medium of claim 127, the network address information including a network address for each direct correspondent of the computer system and a network address and a relationship path for each correspondent of each direct correspondent of the computer system.

131. The memory medium of claim 127 wherein the instructions performed without using an intermediate directory server with a static network address.

132. The memory medium of claim 127 wherein the instructions are performed in conjunction with using an intermediate directory server with a static network address.

133. The memory medium of claim 127 wherein the mutually tracked correspondent computer systems include at least one indirect correspondent of the computer system, and wherein the network address of the at least one indirect correspondent of the computer system is used to automatically determine the current network address of the target computer system.

134. The memory medium of claim 133 wherein the at least one indirect correspondent of the computer system is greater than two levels of correspondents away from the computer system.

135. The memory medium of claim 127 wherein the stored network address information includes Internet Protocol (“IP”) network addresses.

136. The memory medium of claim 127 wherein the stored network address information includes a private local area network (“LAN”) address.

137. A computer system connected over a network to a community of correspondent computer systems, at least one of the computer systems in the community having a dynamically changing network address, comprising:
a tracking agent that is structured to
mutually receive, communicate, store, and update network address information associated with each of the correspondent computer systems in the community; and
a directory service component that is structured to
upon receiving a request for a current network address of a target correspondent computer system in the community, retrieve from the stored network address information a most recent address of the target correspondent computer system and determine whether the retrieved most recent address is current; and
when it is determined that the retrieved most recent address of the target correspondent computer system is not current, use the stored network address information associated with the rest of the correspondent computer systems in the community to communicate with one or more of the rest of the correspondent computer systems to automatically determine the current network address of the target correspondent computer system.

138. The system of claim 137, the directory service structured to communicate with each of the rest of the correspondent computer systems according to a determined order until the current network address of the target correspondent computer system is found or until all of the rest of the correspondent computer systems have been queried.

139. The system of claim 137 wherein the determined order is at least one of correspondent level, a ranking, or a weighting of probable success.

140. The system of claim 137, the network address information including a network address for each direct correspondent of the computer system and a network address and a relationship path for each correspondent of each direct correspondent of the computer system.

141. The system of claim 137 wherein the correspondent computer systems include at least one indirect correspondent of the computer system, and wherein the network address of the at least one indirect correspondent of the computer system is used to automatically determine the current network address of the target computer system.

142. The system of claim 141 wherein the at least one indirect correspondent of the computer system is greater than two levels of correspondents away from the computer system.

143. The system of claim 137 wherein the stored network address information includes Internet Protocol (“IP”) network addresses.

144. The system of claim 137 wherein the stored network address information includes a private local area network (“LAN”) address.

145. A method in a computer system for mutually tracking network addresses in a community of member computer systems that communicate with each other, the computer system having a network address, comprising:
receiving and storing network address information from a plurality of first level correspondents of the computer system, the received network address information of at least one of the plurality of first level correspondents including an indication of a network address of the one of the first level correspondents and an indication of a network address and a relationship path to at least one direct correspondent of the one of the first level correspondents and at least one indirect correspondent of the one of the first level correspondents;
determining that the network address of the computer system has changed; and
sending updated network address information that includes an updated network address of the computer system to direct and indirect correspondents of the plurality of first level correspondents using the stored network address information.

146. The method of claim 145 wherein the stored network address information includes Internet Protocol (“IP”) network addresses.

147. The method of claim 145 wherein the stored network address information includes a private local area network (“LAN”) address.

148. The method of claim 145 wherein the sending the updated network address information is sent to direct and indirect correspondents of the plurality of first level correspondents until a determined threshold level of indirection is reached.

149. The method of claim 145 wherein the sending the updated network address information is sent according to a determined order of correspondents.

150. The method of claim 149 wherein the determined order is at least one of correspondent level, a ranking, or a weighting of probable success.

151. A computer-readable memory medium containing instructions that control a computer process to mutually tracking network addresses in a community of member computer systems that communicate with each other, the computer processor residing in each one of the member computer systems, by:
receiving and storing network address information from a plurality of first level correspondents of the member computer system, the received network address information of at least one of the plurality of first level correspondents including an indication of a network address of the one of the first level correspondents and an indication of a network address and a relationship path to at least one direct correspondent of the one of the first level correspondents and at least one indirect correspondent of the one of the first level correspondents;
determining that the network address of the member omputer system has changed; and
sending updated network address information that includes an updated network address of the member computer system to direct and indirect correspondents of the plurality of first level correspondents using the stored network address information.

152. The memory medium of claim 151 wherein the stored network address information includes Internet Protocol (“IP”) network addresses.

153. The memory medium of claim 151 wherein the stored network address information includes a private local area network (“LAN”) address.

154. The memory medium of claim 151 wherein the sending the updated network address information is sent to direct and indirect correspondents of the plurality of first level correspondents until a determined threshold level of indirection is reached.

155. The memory medium of claim 151 wherein the sending the updated network address information is sent according to a determined order of correspondents.

156. The memory medium of claim 155 wherein the determined order is at least one of correspondent level, a ranking, or a weighting of probable success.

157. A tracking system for mutually tracking network addresses in each of a community of member computer systems that communicate with each other, each computer system having a network address, comprising:
a tracking agent that is structured to receive and store network address information from a plurality of first level correspondents of the member computer system, the received network address information of at least one of the plurality of first level correspondents including an indication of a network address of the one of the first level correspondents and an indication of a network address and a relationship path to at least one direct correspondent of the one of the first level correspondents and at least one indirect correspondent of the one of the first level correspondents; and
a network address update mechanism that is structured to
determine that the network address of the member computer system has changed; and
send updated network address information that includes an updated network address of the member computer system to direct and indirect correspondents of the plurality of first level correspondents using the stored network address information.

158. The system of claim 157 wherein the stored network address information includes Internet Protocol (“IP”) network addresses.

159. The system of claim 157 wherein the stored network address information includes a private local area network (“LAN”) address.

160. The system of claim 157 wherein the sending the updated network address information is sent to direct and indirect correspondents of the plurality of first level correspondents until a determined threshold level of indirection is reached.

161. The system of claim 157 wherein the sending the updated network address information is sent according to a determined order of correspondents.

162. The system of claim 161 wherein the determined order is at least one of correspondent level, a ranking, or a weighting of probable success.
